(19) United States
(12) Patent Application Publication
(10) Pub. No.: US 2026/0331063 A1
(43) Pub. Date: Oct. 22, 2026

(54) DRIVING CIRCUITS AND ELECTRONIC APPARATUSES INCLUDING THE SAME

(71) Applicants: Samsung Display Co., Ltd., Yongin-si (KR); UNIVERSITY-INDUSTRY COOPERATION GROUP OF KYUNG HEE UNIVERSITY, Yongin-si (KR)

(72) Inventors: Donghwan JEON, Yongin-si (KR); Kyonghwan OH, Yongin-si (KR); Seung-Woo LEE, Yongin-si (KR); Won-Been JEONG, Yongin-si (KR)

(73) Assignees: Samsung Display Co., Ltd., Yongin-si (KR); UNIVERSITY-INDUSTRY COOPERATION GROUP OF KYUNG HEE UNIVERSITY, Yongin-si (KR)

(21) Appl. No.: 19/650,479

(22) Filed: Apr. 17, 2026

(30) Foreign Application Priority Data
Apr. 17, 2025 (KR) 10-2025-0050419

(51) Int. Cl. G09G 3/3266

(52) U.S. Cl. CPC G09G 3/3266; G09G 2330/021

(57) ABSTRACT

Provided are a driving circuit and an electronic apparatus including the same, the driving circuit including a plurality of stages, common control circuits configured to control a voltage level of a first control node of each of a consecutive pair of stages among the plurality of stages, and switch transistors configured to electrically connect each of the common control circuits to corresponding stages among the plurality of stages according to clock signals input to gates, each of the plurality of stages includes an input circuit configured to transmit a start signal to a second control node, the start signal being input to an input terminal, a node control circuit configured to control a voltage level of the second control node, a charge pump circuit configured to control a voltage level of a third control node, and an output circuit configured to output a carry signal and an output signal.

### CROSS-REFERENCE TO RELATED APPLICATION

This application is based on and claims priority to Korean Patent Application No. 10-2025-0050419, filed on Apr. 17, 2025, in the Korean Intellectual Property Office, the disclosure of which is incorporated by reference herein in its entirety.

### BACKGROUND

### 1. Field

Some example embodiments relate to a driving circuit and an electronic apparatus including the same.

### 2. Description of the Related Art

A display apparatus includes a pixel unit including a plurality of pixels, a gate driving circuit, an emission control driving circuit, a data driving circuit, and a controller. Each of the plurality of pixels includes a light-emitting diode as a display element, and a pixel circuit configured to control the luminance of the light-emitting diode. The pixel circuit includes transistors and at least one capacitor. The transistors may include a driving transistor and a switching transistor that is turned on or turned off according to a gate signal.

The gate driving circuit includes stages connected to gate lines, and each of the stages supplies a gate signal to a corresponding gate line. The emission control driving circuit includes stages connected to emission control lines, and each of the stages supplies an emission control signal to a corresponding emission control line.

### SUMMARY

An emission control driving circuit is required (or used) to stably output an emission control signal as an on voltage for a relatively long period of time.

Some example embodiments include a driving circuit configured to stably output an emission control signal and an electronic apparatus including the same. However, some example embodiments are only examples, and the scope of the disclosure is not limited thereto.

Additional aspects will be set forth in part in the following description and, in part, will be apparent from the description, or may be learned by practice of the presented examples of the disclosure.

According some example embodiments, a driving circuit includes a plurality of stages, common control circuits configured to control a voltage level of a first control node of each of a consecutive pair of stages among the plurality of stages, and switch transistors configured to electrically connect each of the common control circuits to corresponding stages among the plurality of stages according to clock signals input to gates of the switch transistors, each of the plurality of stages including an input circuit configured to transmit a start signal to a second control node according to a first clock signal input to a first clock terminal, the start signal being input to an input terminal, and the first clock signal being among the clock signals, a node control circuit configured to control a voltage level of the second control node, a charge pump circuit configured to control a voltage level of a third control node according to a second clock signal input to a second clock terminal, the second clock signal being among the clock signals, and an output circuit configured to output a carry signal to a first output terminal based on the voltage level of the first control node and the voltage level of the third control node, and output an output signal to a second output terminal based on the voltage level of the first control node and the voltage level of the third control node.

In some example embodiments, the plurality of stages may include a (2k−1)^{th} stage and a 2k^{th} stage that are electrically connected to a k^{th} common control circuit among the common control circuits, the second clock signal may be phase-shifted by a half cycle from the first clock signal, the first clock signal may be input to the first clock terminal of the (2k−1)^{th} stage, the second clock signal may be input to the second clock terminal of the (2k−1)^{th} stage, the second clock signal may be input to the first clock terminal of the 2k^{th} stage, the first clock signal may be input to the second clock terminal of the 2k^{th} stage, and k may be a natural number greater than or equal to 1.

In some example embodiments, the k^{th} common control circuit may include a first transistor electrically connected between a first node and a double clock terminal to which a double clock signal is input, the first transistor including a gate electrically connected to a second node, a second transistor electrically connected between the first node and a first voltage terminal to which a first low level voltage is supplied, the second transistor including a gate electrically connected to the second control node of the (2k−1)^{th} stage, a third transistor electrically connected between the second node and the first voltage terminal, the third transistor including a gate electrically connected to the input terminal of the (2k−1)^{th} stage, and a first capacitor electrically connected between the double clock terminal and the second node.

In some example embodiments, the switch transistors may include a first switch transistor configured to electrically connect the k^{th} common control circuit to the (2k−1)^{th} stage according to the first clock signal, and a second switch transistor configured to electrically connect the k^{th} common control circuit to the 2k^{th} stage according to the second clock signal.

In some example embodiments, the first switch transistor may be electrically connected between the first node of the k^{th} common control circuit and the second control node of the (2k−1)^{th} stage, and the second switch transistor may be electrically connected between the first node of the k^{th} common control circuit and the second control node of the 2k^{th} stage.

In some example embodiments, one period of the double clock signal may be longer than one period of each of the clock signals.

In some example embodiments, one period of the double clock signal may be twice as long as one period of each of the clock signals.

In some example embodiments, each of the first transistor, the second transistor, and the third transistor may include two sub-transistors connected in series, the k^{th} common control circuit may include a fourth transistor electrically connected between a first sub-node and a second voltage terminal to which a high-level voltage is supplied, the sub-transistors of the first transistor being connected to each other at the first sub-node, a fifth transistor electrically connected between a second sub-node and the second voltage terminal, the sub-transistors of the second transistor being connected to each other at the second sub-node, and a sixth transistor electrically connected between a third sub-node and the second voltage terminal, the sub-transistors of the third transistor being connected to each other at the third sub-node, and a gate of each of the fourth transistor, the fifth transistor, and the sixth transistor may be electrically connected to the first node.

In some example embodiments, the k^{th} common control circuit may include a first transistor electrically connected between a first node and a first voltage terminal to which a high-level voltage is supplied, the first transistor including a gate electrically connected to the first voltage terminal, and a second transistor electrically connected between the first node and a second voltage terminal to which a low-level voltage is supplied, the second transistor including a gate electrically connected to the second control node of the (2k−1)^{th} stage.

In some example embodiments, the input circuit may include a first transistor electrically connected between the input terminal and the second control node, the first transistor including a gate electrically connected to the first clock terminal, and the node control circuit may include a second transistor electrically connected between the second control node and a first voltage terminal to which a first low level voltage is supplied, the second transistor including a gate electrically connected to the first control node.

In some example embodiments, the second transistor may include two sub-transistors connected in series, and each of the plurality of stages may include a third transistor electrically connected between a fourth sub-node and a second voltage terminal to which a high-level voltage is supplied, the sub-transistors of the second transistor being connected to each other at the fourth sub-node, and the third transistor including a gate electrically connected to the second control node.

In some example embodiments, the output circuit may include a first transistor electrically connected between the first output terminal and a first voltage terminal to which a high-level voltage is supplied, the first transistor including a gate electrically connected to the third control node, a second transistor electrically connected between the first output terminal and a second voltage terminal to which a first low level voltage is supplied, the second transistor including a gate electrically connected to the first control node, a third transistor electrically connected between the first voltage terminal and the second output terminal, the third transistor including a gate electrically connected to the third control node, and a fourth transistor electrically connected between the second output terminal and a third voltage terminal to which a second low level voltage is supplied, the fourth transistor including a gate electrically connected to the first control node.

In some example embodiments, the output circuit may further include a first capacitor electrically connected between the gate of the third transistor and the second output terminal, and a second capacitor electrically connected between the gate of the fourth transistor and the third voltage terminal.

In some example embodiments, the first output terminal may be electrically connected to the input terminal of a subsequent stage, and the second output terminal may be electrically connected to a corresponding emission control line.

In some example embodiments, the charge pump circuit may include a first transistor electrically connected to the second clock terminal, the first transistor including a gate electrically connected to the third control node, and a first capacitor electrically connected between the first transistor and the third control node.

In some example embodiments, the plurality of stages and the common control circuits may each include a plurality of transistors, and each of the plurality of transistors may include an oxide thin-film transistor that includes an oxide semiconductor material.

According to some example embodiments, an electronic apparatus includes a main processor, a display apparatus including a pixel and a driving circuit, the driving circuit being configured to supply an output signal to the pixel, and a controller electrically connected to the display apparatus, the controller bring configured to output a driving control signal to the display apparatus based on a signal received from the main processor, the driving circuit includes a plurality of stages configured to control a voltage level of each of a first control node, a second control node, and a third control node based on a start signal and clock signals, and output a carry signal and the output signal based on the voltage level of each of the first control node, the second control node, and the third control node, common control circuits configured to control the voltage level of the first control node of each of a consecutive pair of stages among the plurality of stages, and switch transistors configured to electrically connect each of the common control circuits to corresponding stages among the plurality of stages according to the clock signals input to gates of the switch transistors.

In some example embodiments, each of the plurality of stages may include an input circuit configured to transmit the start signal according to a first clock signal input to a first clock terminal, the start signal being input into an input terminal, and the first clock signal being among the clock signals, a node control circuit configured to control the voltage level of the second control node, a charge pump circuit configured to control the voltage level of the third control node according to a second clock signal input to a second clock terminal, the second clock signal being among the clock signals, and an output circuit configured to output the carry signal to a first output terminal based on the voltage level of the first control node and the voltage level of the third control node, and output the output signal to a second output terminal based on the voltage level of the first control node and the voltage level of the third control node.

In some example embodiments, the plurality of stages may include a (2k−1)^{th} stage and a 2k^{th} stage that are electrically connected to a k^{th} common control circuit among the common control circuits, and the k^{th} common control circuit may include a first transistor electrically connected between a first node and a double clock terminal to which a double clock signal is input, the first transistor including a gate electrically connected to a second node, a second transistor electrically connected between the first node and a first voltage terminal to which a first low level voltage is supplied, the second transistor including a gate electrically connected to the second control node of the (2k−1)^{th} stage, a third transistor electrically connected between the second node and the first voltage terminal, the third transistor including a gate electrically connected to the input terminal of the (2k−1)^{th} stage, and a first capacitor electrically connected between the double clock terminal and the second node.

In some example embodiments, the plurality of stages may include a (2k−1)^{th} stage and a 2k^{th} stage that are electrically connected to a k^{th} common control circuit among the common control circuits, and the k^{th} common control circuit may include a first transistor electrically connected between a first node and a first voltage terminal to which a high-level voltage is supplied, the first transistor including a gate electrically connected to the first voltage terminal, and a second transistor electrically connected between the first node and a second voltage terminal to which a low-level voltage is supplied, second transistor including a gate electrically connected to the second control node of the (2k−1)^{th} stage.

Other aspects, features, and advantages other than those described above will become apparent from the following drawings, claims, and detailed description of the disclosure.

### BRIEF DESCRIPTION OF THE DRAWINGS

The above and other aspects, features, and advantages of some example embodiments of the disclosure will be more apparent from the following description taken in conjunction with the accompanying drawings, in which:

FIG. 1 is a schematic view of a display apparatus according to some example embodiments;

FIG. 2 is a schematic view of a driving circuit according to some example embodiments;

FIG. 3 is a circuit diagram schematically illustrating some example embodiments of a stage included in the driving circuit of FIG. 2;

FIG. 4 is a timing diagram for explaining the driving of the stage of FIG. 3;

FIGS. 5A to 5C are diagrams for schematically explaining operation of a second node control circuit;

FIG. 6 is a graph illustrating power consumption of a driving circuit according to a comparative example and power consumption of a driving circuit according to some example embodiments;

FIG. 7 is a schematic view of a driving circuit according to some example embodiments;

FIG. 8 is a block diagram schematically illustrating some example embodiments of two adjacent stages included in the driving circuit shown in FIG. 7;

FIG. 9 is a circuit diagram schematically illustrating some example embodiments of two adjacent stages included in the driving circuit shown in FIG. 7;

FIG. 10 is a timing diagram for explaining the driving of the stages of FIG. 9;

FIGS. 11A to 11D are diagrams for schematically explaining operation of stages;

FIG. 12 is a circuit diagram schematically illustrating some example embodiments of two adjacent stages included in a driving circuit according to some example embodiments;

FIG. 13 is a block diagram of an electronic apparatus according to some example embodiments; and

FIGS. 14 to 16 are schematic views of electronic apparatuses according to some example embodiments.

### DETAILED DESCRIPTION

Reference will now be made in detail to some example embodiments, examples of which are illustrated in the accompanying drawings, wherein like reference numerals refer to like elements throughout the specification. In this regard, the present examples may have different forms and should not be construed as being limited to the descriptions set forth herein. Accordingly, the examples are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Various modifications may be applied to the present examples, and particular examples will be illustrated in the drawings and described in the detailed description section. The effect and features of the disclosure, and a method to achieve the same, will be clearer referring to the detailed descriptions below with the drawings. However, the present examples may be implemented in various forms, not by being limited to the examples presented below.

Hereinafter, some example embodiments of the disclosure will be described in detail with reference to the accompanying drawings, and in the description with reference to the drawings, the same or corresponding components are indicated by the same reference numerals (or similar reference numerals) and redundant descriptions thereof are omitted.

In the present specification, it will be understood that although the terms “first,” “second,” etc. may be used herein to describe various components, these components should not be limited by these terms. These terms are only used to distinguish one component from another.

In the present specification, the expression of singularity in the present specification includes the expression of plurality unless clearly specified otherwise in context.

In the present specification, it will be further understood that the terms “comprises” and/or “comprising” used herein specify the presence of stated features or components, but do not preclude the presence or addition of one or more other features or components.

In the present specification, it will be understood that when a layer, area, or component is referred to as being “formed on” another layer, area, or component, it may be directly or indirectly formed on the other layer, area, or component. That is, for example, intervening layers, areas, or components may be present.

In the present specification, it will be understood that when a layer, area, or component is referred to as being “connected to” another layer, area, or component, it may be directly or indirectly connected to the other layer, area, or component. That is, for example, intervening layers, areas, or components may be present. For example, in the present specification, when a layer, area, or component is electrically connected to another layer, area, or component, the layers, areas, or components may not only be directly electrically connected, but may also be indirectly electrically connected via another layer, area, or component therebetween.

In the present specification, the expression “A and/or B” represents A, B, or A and B. In addition, the expression “at least one of A and B” represents A, B, or A and B.

In the present specification, the x direction, the y direction, and the z direction are not limited to three axes of the rectangular coordinate system, and may be interpreted in a broader sense. For example, the x direction, the y direction, and the z direction may be perpendicular to one another, or may represent different directions that are not perpendicular to one another.

In the present specification, the term “in a plan view” refers to when a target portion is viewed from above (for example, when viewed in a direction perpendicular to a top surface of a substrate), and the term “in a cross-section” refers to a side view of a vertically cut cross-section of a target portion.

In the present specification, when a first component “overlaps” a second component, it means that the first component is arranged above or under the second component such that they overlap each other at least partially in a plan view.

In the present specification, the term “on” used in relation to a device state may refer to an active state of a device, and the term “off” may refer to an inactive state of a device. The term “on” used in relation to a signal received by a device may denote a signal for activating a device, and the term “off” may denote a signal for inactivating (or deactivating) a device. A device may be activated according to a high-level voltage or a low-level voltage. For example, a P-channel transistor (a P-type transistor) is activated according to a low-level voltage, and an N-channel transistor (an N-type transistor) is activated according to a high-level voltage. Therefore, it should be construed that “on” voltages applied to the P-channel and N-channel transistors are opposite to each other (low vs. high).

In the present specification, when a certain example may be implemented differently, a specific process order may be performed differently from the described order. For example, two consecutively described processes may be performed substantially at the same time or performed in an order opposite to the described order.

Sizes of components in the drawings may be exaggerated or reduced for convenience of explanation. In other words, since sizes and thicknesses of components in the drawings are arbitrarily illustrated for convenience of explanation, the following examples are not limited thereto.

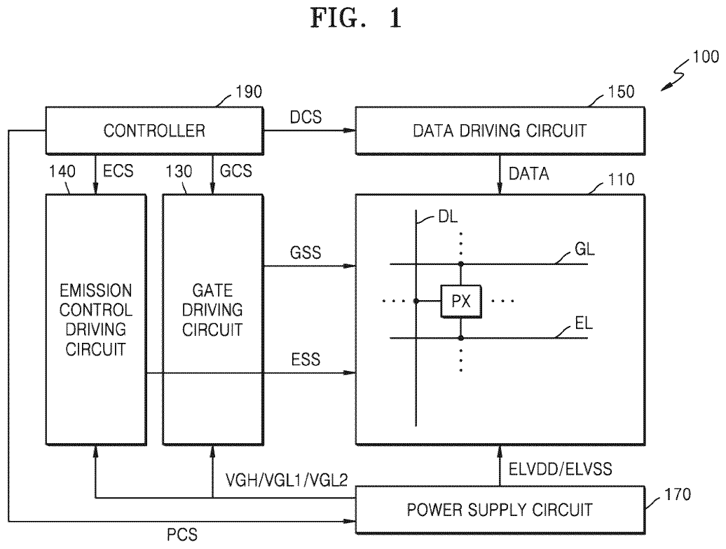

FIG. 1 is a schematic view of a display apparatus according to some example embodiments.

Referring to FIG. 1, a display apparatus 100 according to some example embodiments may include a pixel unit 110, a gate driving circuit 130, an emission control driving circuit 140, a data driving circuit 150, a power supply circuit 170, and/or a controller 190. According to some example embodiments, operations described herein as being performed by the display apparatus 100, the gate driving circuit 130, the emission control driving circuit 140, the data driving circuit 150, the power supply circuit 170, and/or the controller 190 may be performed by processing circuitry. The term ‘processing circuitry,’ as used in the present disclosure, may refer to, for example, hardware including logic circuits; a hardware such as a processor executing software; a hardware/software combination, or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The pixel unit 110 may correspond to a display area in which an image is displayed. Various conductive lines configured to transmit an electrical signal to be applied to the display area, peripheral driving circuits electrically connected to pixel circuits, and pads to which a printed circuit board or a driver integrated circuit (IC) chip is attached may be located in a peripheral area (a non-display area) outside the display area. For example, the gate driving circuit 130, the emission control driving circuit 140, the data driving circuit 150, the power supply circuit 170, and/or the controller 190 may be provided in the peripheral area.

A plurality of gate lines GL, a plurality of emission control lines EL, a plurality of data lines DL, and a plurality of pixels PX connected to the plurality of gate lines GL, the plurality of emission control lines EL, and the plurality of data lines DL may be arranged in the pixel unit 110. The plurality of pixels PX may be repeatedly arranged in a first direction (for example, a row direction) and a second direction (for example, a column direction). The plurality of pixels PX may be arranged in various shapes, such as a stripe arrangement, a Pentile® arrangement, a diamond arrangement, or a mosaic arrangement. Each of the plurality of pixels PX may include an organic light-emitting diode as a display element, and the organic light-emitting diode may be connected to a pixel circuit. The pixel circuit may include a plurality of transistors and at least one capacitor. Each of the pixels PX may emit, for example, red light, green light, blue light, or white light through the display element. Each pixel PX may be connected to a corresponding gate line among the plurality of gate lines GL, a corresponding emission control line among the plurality of emission control lines EL, and a corresponding data line among the plurality of data lines DL.

In some example embodiments, the plurality of transistors included in the pixel circuit may be N-type oxide transistors. In some example embodiments, the plurality of transistors included in the pixel circuit may be P-type silicon transistors. In some example embodiments, some of the plurality of transistors included in the pixel circuit may be N-type oxide transistors, and some others may be P-type silicon transistors.

Each of the gate lines GL may extend in the first direction (for example, the row direction) and be connected to pixels PX located in the same row (or a similar row). Each of the gate lines GL may be configured to transmit a gate signal GSS to the pixels PX in the same row (or a similar row). Each of the emission control lines EL may extend in the first direction (for example, the row direction) and be connected to pixels PX located in the same row (or a similar row). Each of the emission control lines EL may be configured to transmit an emission control signal ESS to the pixels PX in the same row (or a similar row). Each of the data lines DL may extend in the second direction (for example, the column direction) and be connected to pixels PX located in the same column (or a similar column). Each of the data lines DL may be configured to transmit a data signal DATA to each of the pixels PX in the same column (or a similar column), in synchronization with the gate signal GSS.

The gate driving circuit 130 may be connected to the plurality of gate lines GL and may be configured to generate the gate signal GSS in response to a gate driving control signal GCS from the controller 190 and sequentially supply the gate signal GSS to the gate lines GL. A gate line GL may be connected to a gate of a transistor included in a pixel PX, and the gate signal GSS may be a gate control signal that controls turning on and turning off of the transistor to which the gate line GL is connected. The gate signal GSS may include a gate-on voltage that may turn on the transistor and a gate-off voltage that may turn off the transistor. The gate driving circuit 130 may include a plurality of stages that sequentially generate and output the gate signal GSS.

The emission control driving circuit 140 may be connected to the plurality of emission control lines EL and may be configured to generate the emission control signal ESS in response to an emission driving control signal ECS from the controller 190 and sequentially supply the emission control signal ESS to the emission control lines EL. An emission control line EL may be connected to a gate of an emission control transistor included in the pixel PX, and the emission control signal ESS may be a gate control signal that controls turning on and turning off of the emission control transistor to which the emission control line EL is connected. The emission control signal ESS may include a gate-on voltage at which the emission control transistor may be turned on and a gate-off voltage at which the emission control transistor may be turned off. The emission control driving circuit 140 may include a plurality of stages that sequentially generate and output the emission control signal ESS.

In this regard, the emission control transistor may be defined as a transistor arranged between a driving transistor and a first power voltage line configured to transmit a first power voltage EVLDD to the pixel PX and/or between the driving transistor and the organic light-emitting diode. When the emission control transistor is turned on, a current path through which a driving current is transmitted to the organic light-emitting diode is formed, and thus, the pixel PX may emit light with a luminance corresponding to the data signal DATA.

The number of stages included in the gate driving circuit 130 and the number of stages included in the emission control driving circuit 140 may vary depending on the number of rows (horizontal lines) of the pixel PX provided in the pixel unit 110.

The data driving circuit 150 may be connected to the plurality of data lines DL, and may be configured to supply the data signal DATA to the data lines DL in response to a data driving control signal DCS from the controller 190. The data signal DATA supplied to the data lines DL may be supplied to the pixels PX selected by the gate signal GSS. The data driving circuit 150 may be configured to convert image data having gray levels, which is input from the controller 190, into the data signal DATA in the form of voltage or current.

The power supply circuit 170 may be configured to generate signals (voltages and currents) required (or used) for driving the pixel unit 110 in response to a power driving control signal PCS from the controller 190. When the display apparatus 100 is an organic light-emitting display apparatus including an organic light-emitting diode, the power supply circuit 170 may be configured to generate the first power voltage EVLDD and a second power voltage ELVSS and supply them to the pixel unit 110. The first power voltage EVLDD may be a high-level voltage provided to one terminal of the driving transistor connected to a first electrode (a pixel electrode or an anode) of the organic light-emitting diode of each pixel PX. The second power voltage ELVSS may be a low-level voltage provided to a second electrode (an opposite electrode or a cathode) of the organic light-emitting diode. The first power voltage EVLDD and the second power voltage ELVSS may be driving voltages for emitting light from the plurality of pixels PX.

The power supply circuit 170 may be configured to generate a first voltage VGH, a second voltage VGL1, and a third voltage VGL2 and supply them to the gate driving circuit 130 and the emission control driving circuit 140. The first voltage VGH may be a high-level voltage, and the second voltage VGL1 and the third voltage VGL2 may each be a low-level voltage. In some example embodiments, the third voltage VGL2 may be lower than the second voltage VGL1. In addition, the power supply circuit 170 may be configured to generate a plurality of clock signals and a start signal and supply them to the gate driving circuit 130 and the emission control driving circuit 140.

The controller 190 may be configured to generate the gate driving control signal GCS, the emission driving control signal ECS, the data driving control signal DCS, and the power driving control signal PCS, based on signals input from the outside (or an external source), for example, signals input from a main processor such as an application processor. The controller 190 may be configured to supply the gate driving control signal GCS to the gate driving circuit 130, supply the emission driving control signal ECS to the emission control driving circuit 140, supply the data driving control signal DCS to the data driving circuit 150, and supply the power driving control signal PCS to the power supply circuit 170.

Although FIG. 1 shows the display apparatus 100 with the power supply circuit 170 and the controller 190 as separate components from a functional viewpoint, the disclosure is not limited thereto. In some example embodiments, the power supply circuit 170 may be included in the controller 190.

The display apparatus 100 may include a display panel, and the display panel may include a substrate. The pixels PX may be arranged in a display area of the substrate. A portion or all of the gate driving circuit 130 and a portion or all of the emission control driving circuit 140 may be directly formed in a peripheral area of the substrate during a process of forming a pixel circuit in the display area of the substrate. The data driving circuit 150, the power supply circuit 170, and the controller 190 may be formed either as separate integrated circuit chips or as a single integrated circuit chip, and may be arranged on a printed circuit board electrically connected to a pad arranged on one side of the substrate. In some example embodiments, the data driving circuit 150, the power supply circuit 170, and the controller 190 may be directly arranged on the substrate using a chip on glass (COG) or chip on plastic (COP) method.

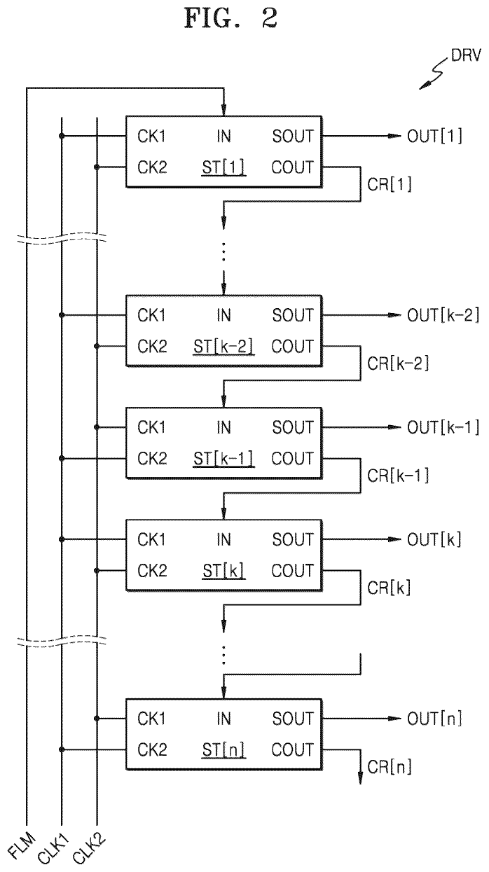

FIG. 2 is a schematic view of a driving circuit according to some example embodiments.

Referring to FIG. 2, a driving circuit DRV according to some example embodiments may include a plurality of stages ST[1] to ST[n]. The stages ST[1] to ST[n] may sequentially output output signals OUT[1] to OUT[n] and carry signals CR[1] to CR[n] to signal lines. According to some example embodiments, n and k may represent an integer. According to some example embodiments, the driving circuit DRV may be used to implement the emission control driving circuit 140, but this is merely an example and some examples are not limited thereto. According to some example embodiments, the driving circuit DRV may be used to implement one or more among the gate driving circuit 130 and/or the emission control driving circuit 140.

Each of the stages ST[1] to ST[n] may include a plurality of terminals to which a plurality of signals are input. The plurality of signals may include a start signal, clock signals CLK1 and CLK2, and voltage signals. The plurality of terminals may include an input terminal IN, a first clock terminal CK1, a second clock terminal CK2, a voltage terminal (not illustrated), an output terminal SOUT, and a carry output terminal COUT.

The start signal may be input to the input terminal IN. The stages ST[1] to ST[n] may respectively output the output signals OUT[1] to OUT[n] in response to the start signal. The start signal may be an external signal FLM or a carry signal (hereinafter, a previous carry signal) output from a previous stage. For example, the external signal FLM may be input as a start signal to the input terminal IN of the first stage ST[1], and the carry signal output from the previous stage may be input as a start signal to the input terminal IN of each of the second to n^{th} stages ST[2] to ST[n]. The previous stage may be a stage located at least one stage before a current stage. For example, the (k−1)^{th} carry signal CR[k−1] output from the (k−1)^{th} stage ST[k−1] may be input as a start signal to the input terminal IN of the k^{th} stage ST[k].

The first clock signal CLK1 or the second clock signal CLK2 may be input to the first clock terminal CK1, and the second clock signal CLK2 or the first clock signal CLK1 may be input to the second clock terminal CK2. In some example embodiments, the first clock signal CLK1 may be input to the first clock terminal CK1 of each of the odd-numbered stages (ST[1], ST[3], . . . ), and the second clock signal CLK2 may be input to the second clock terminal CK2 of each of the odd-numbered stages (ST[1], ST[3], . . . ). The second clock signal CLK2 may be input to the first clock terminal CK1 of each of the even-numbered stages (ST[2], ST[4], . . . ), and the first clock signal CLK1 may be input to the second clock terminal CK2 of each of the even-numbered stages ST[2], ST[4], . . . ). In some example embodiments, the second clock signal CLK2 may be phase-shifted by a half cycle relative to the first clock signal CLK1. A half cycle of a clock signal may be one line time. In some example embodiments, the first clock signal CLK1 and the second clock signal CLK2 may be square wave signals that alternate between a high-level voltage and a low-level voltage. For example, the first clock signal CLK1 and the second clock signal CLK2 may be square wave signals that alternate between the first voltage VGH, which is a high level, and the third voltage VGL2, which is a second low level.

Each of the stages ST[1] to ST[n] may output an output signal from the output terminal SOUT, in synchronization with a clock signal. The output signals OUT[1] to OUT[n] output from the output terminals SOUT of the stages ST[1] to ST[n] may be sequentially shifted by a certain period. In some example embodiments, the stages ST[1] to ST[n] may sequentially output the output signals OUT[1] to OUT[n] at a high-level voltage by shifting them by one line time.

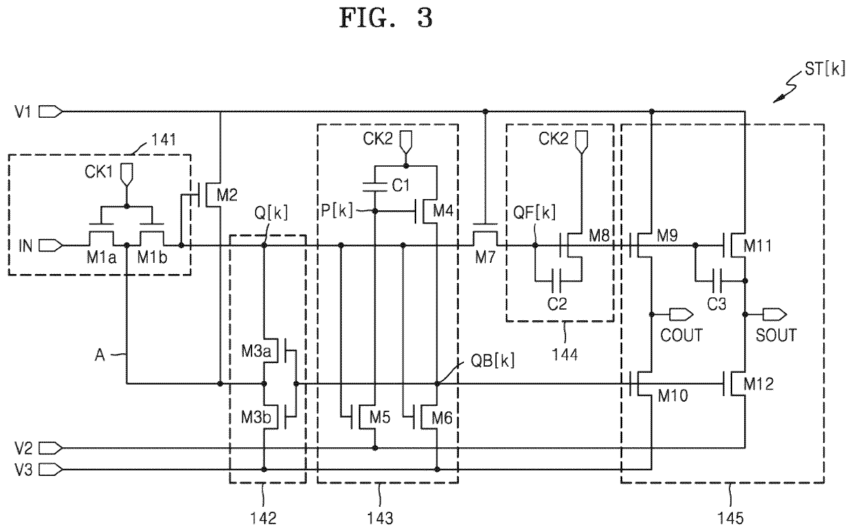

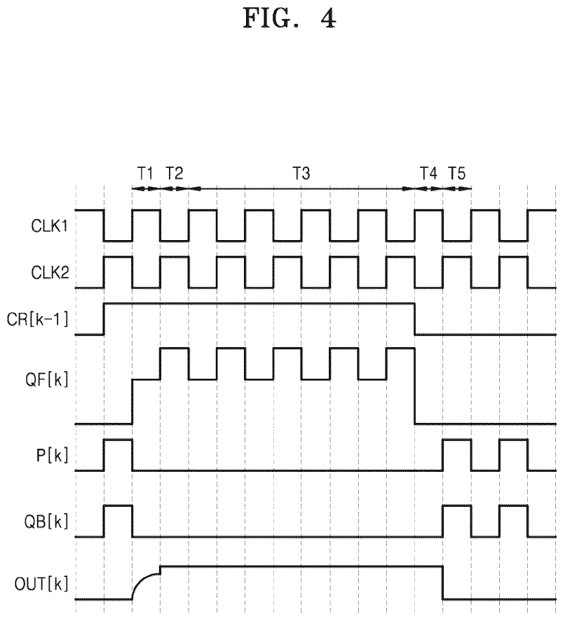

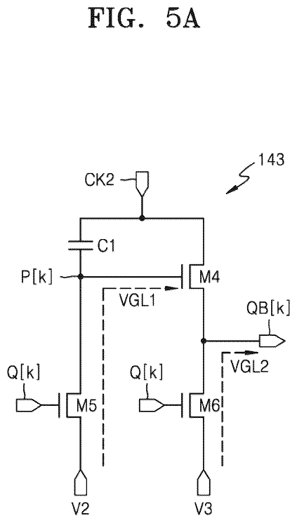

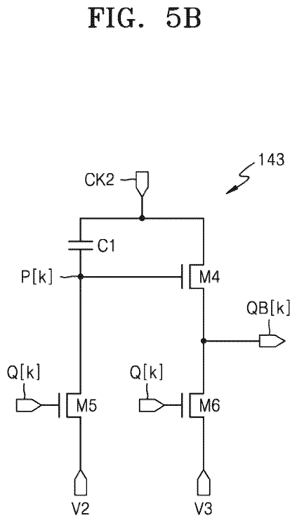

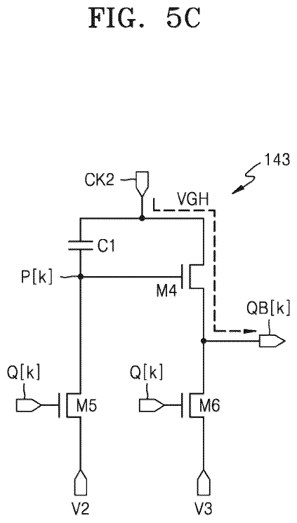

FIG. 3 is a circuit diagram schematically illustrating some example embodiments of a stage included in the driving circuit of FIG. 2. FIG. 4 is a timing diagram for explaining the driving of the stage of FIG. 3. FIGS. 5A to 5C are diagrams for schematically explaining operation of a second node control circuit.

Referring to FIGS. 3 and 4 together, the k^{th} stage ST[k] may include an input circuit 141, a first node control circuit 142, a second node control circuit 143, a charge pump circuit 144, and/or an output circuit 145. The k^{th} stage ST[k] may be connected to the input terminal IN, the first clock terminal CK1, the second clock terminal CK2, a first voltage terminal V1, a second voltage terminal V2, a third voltage terminal V3, the carry output terminal COUT, and the output terminal SOUT. The (k−1)^{th} carry signal CR[k−1] may be input to the input terminal IN of the k^{th} stage ST[k], the first clock signal CLK1 may be input to the first clock terminal CK1, the second clock signal CLK2 may be input to the second clock terminal CK2, the first voltage VGH, which is a high-level voltage, may be supplied to the first voltage terminal V1, the second voltage VGL1, which is a first low level voltage, may be supplied to the second voltage terminal V2, and the third voltage VGL2, which is a second low level voltage, may be supplied to the third voltage terminal V3. The k^{th} carry signal CR[k] may be output to the carry output terminal COUT, and the k^{th} output signal OUT[k] may be output to the output terminal SOUT.

The k^{th} stage ST[k] may include a plurality of transistors M1, . . . , and M12 and capacitors C1, C2, and C3. In some example embodiments, the transistors M1, . . . , and M12 may be N-type transistors. A gate-on voltage of an N-type transistor may be a high-level voltage, and a gate-off voltage thereof may be a low-level voltage. In some example embodiments, the transistors M1, . . . , and M12 may be P-type transistors. A gate-on voltage of a P-type transistor may be a low-level voltage, and a gate-off voltage thereof may be a high-level voltage.

Depending on the type (p-type or n-type) of transistor and/or operating conditions, a first terminal of each of the transistors M1, . . . , and M12 may be either a source or a drain, and a second terminal thereof may be different from the first terminal. For example, when the first terminal is a source, the second terminal may be a drain.

The input circuit 141 may be configured to transmit, to a second control node Q[k], the start signal input to the input terminal IN, according to a clock signal input to the first clock terminal CK1. For example, the input circuit 141 may include a gate electrically connected to the first clock terminal CK1, and may include first and second sub-transistors M1a and M1b of the first transistor M1 electrically connected between the input terminal IN and the second control node Q[k]. The first transistor M1 may include the two sub-transistors M1a and M1b connected in series.

The first node control circuit 142 may be configured to control a voltage level of the second control node Q[k], based on a voltage level of a first control node QB[k]. The first node control circuit 142 may include a gate electrically connected to the first control node QB[k], and may include first and second sub-transistors M3a and M3b of the third transistor M3 electrically connected between the second control node Q[k] and the third voltage terminal V3. The third transistor M3 may include the two sub-transistors M3a and M3b connected in series.

The second terminal of the first sub-transistor M1a of the first transistor M1 and the first terminal of the second sub-transistor M1b may be electrically connected to a first sub-node A. The second terminal of the first sub-transistor M3a of the third transistor M3 and the first terminal of the second sub-transistor M3b may be electrically connected to the first sub-node A. The second transistor M2 may include a gate electrically connected to the second control node Q[k], and may be electrically connected between the first voltage terminal V1 and the first sub-node A. The second transistor M2 may be turned on when a voltage level of the second control node Q[k] is a high level, and may be configured to transmit, to the first sub-node A, the first voltage VGH input to the first voltage terminal V1.

The second node control circuit 143 may be configured to control a voltage level of the first control node QB[k], based on a clock signal input to the second clock terminal CK2 and a voltage level of the second control node Q[k]. The second node control circuit 143 may include the fourth transistor M4, the fifth transistor M5, the sixth transistor M6, and the first capacitor C1. The fourth transistor M4 may include a gate electrically connected to a first node P[k], and may be electrically connected between the second clock terminal CK2 and the first control node QB[k]. The fifth transistor M5 may include a gate electrically connected to the second control node Q[k], and may be electrically connected between the first node P[k] and the second voltage terminal V2. The sixth transistor M6 may include a gate electrically connected to the second control node Q[k], and may be electrically connected between the first control node QB[k] and the third voltage terminal V3. The first capacitor C1 may be electrically connected between the second clock terminal CK2 and the first node P[k].

The charge pump circuit 144 may be configured to control a voltage level of a third control node QF[k] according to a clock signal input to the second clock terminal CK2. The charge pump circuit 144 may include the eighth transistor M8 and the second capacitor C2. The eighth transistor M8 may include a gate electrically connected to the third control node QF[k], and may be electrically connected between the second clock terminal CK2 and the second capacitor C2. The second capacitor C2 may be electrically connected between the eighth transistor M8 and the third control node QF[k].

The seventh transistor M7 may include a gate electrically connected to the first voltage terminal V1, and may be electrically connected between the second control node Q[k] and the third control node QF[k].

The output circuit 145 may be configured to output the k^{th} carry signal CR[k] (see FIG. 2) to the carry output terminal COUT, based on a voltage level of the first control node QB[k] and a voltage level of the third control node QF[k], and may be configured to output the k^{th} output signal OUT[k] (see FIG. 2) to the output terminal SOUT. The output circuit 145 may include the ninth transistor M9, the tenth transistor M10, the eleventh transistor M11, the twelfth transistor M12, and the third capacitor C3. The ninth transistor M9 may include a gate electrically connected to the third control node QF[k], and may be electrically connected between the first voltage terminal V1 and the carry output terminal COUT. The tenth transistor M10 may include a gate electrically connected to the first control node QB[k], and may be electrically connected between the third voltage terminal V3 and the carry output terminal COUT. The eleventh transistor M11 may include a gate electrically connected to the third control node QF[k], and may be electrically connected between the first voltage terminal V1 and the output terminal SOUT. The twelfth transistor M12 may include a gate electrically connected to the first control node QB[k], and may be electrically connected between the second voltage terminal V2 and the output terminal SOUT. The third capacitor C3 may be electrically connected between the gate of the eleventh transistor M11 and the output terminal SOUT.

FIG. 4 shows the first clock signal CLK1 input to the first clock terminal CK1 of the k^{th} stage ST[k], the second clock signal CLK2 input to the second clock terminal CK2, the (k−1)^{th} carry signal CR[k−1] input as a start signal to the input terminal IN, a voltage level of the third control node QF[k], a voltage level of the first node P[k], a voltage level of the first control node QB[k], and the k^{th} output signal OUT[k]. Except that the external signal FLM is input as a start signal to the input terminal IN, the first stage ST[1] may operate in the same manner as (or a similar manner to) that described below. Except that the second clock signal CLK2 is input to the first clock terminal CK1 and the first clock signal CLK1 is input to the second clock terminal CK2, the even-numbered stages may operate in substantially the same manner as the odd-numbered stages.

During a first period T1, the (k−1)^{th} carry signal CR[k−1] at the first voltage VGH may be supplied to the input terminal IN from a previous stage, the first clock signal CLK1 at the first voltage VGH may be supplied to the first clock terminal CK1, and the second clock signal CLK2 at the third voltage VGL2 may be supplied to the second clock terminal CK2. The (k−1)^{th} carry signal CR[k−1] may be a carry signal output from the previous stage.

The first and second sub-transistors M1a and M1b of the first transistor M1 may be turned on by the first clock signal CLK1 at the first voltage VGH. By the turned-on first and second sub-transistors M1a and M1b of the first transistor M1, the (k−1)^{th} carry signal CR[k−1] at the first voltage VGH may be transmitted to the second control node Q[k], and a voltage level of the second control node Q[k] may transition from a low level to a high level. Accordingly, the second transistor M2, the ninth transistor M9, and the eleventh transistor M11 may be turned on. The first voltage terminal V1 and the first sub-node A may be electrically connected to each other by the turned-on second transistor M2, and the first voltage VGH may be supplied to the first sub-node A. A voltage level of the k^{th} output signal OUT[k] may be increased by the turned-on eleventh transistor M11. As the voltage level of the k^{th} output signal OUT[k] increases from a low level to a high level, the voltage level of the third control node QF[k] may be bootstrapped to a voltage level higher than the first voltage VGH by coupling of the third capacitor C3. The third capacitor C3 may store an amount of charge corresponding to a voltage difference between the output terminal SOUT and the third control node QF[k]. In this case, due to a load on an output signal line (for example, the emission control line EL (see FIG. 1)), the voltage level of the k^{th} output signal OUT[k] may increase slowly and may fail to reach the first voltage VGH.

FIG. 5A illustrates operation of the second node control circuit 143 during the first period T1. Referring to FIG. 5A, during the first period T1, the voltage level of the second control node Q[k] may be maintained at a high level, and the second clock signal CLK2 at the third voltage VGL2 may be supplied to the second clock terminal CK2. Accordingly, the fifth transistor M5 and the sixth transistor M6 may be turned on. The second voltage VGL1 may be supplied from the second voltage terminal V2 to the first node P[k] by the turned-on fifth transistor M5, and the fourth transistor M4 may be turned off. The third voltage VGL2 may be supplied from the third voltage terminal V3 to the first control node QB[k] by the turned-on sixth transistor M6. Accordingly, the first and second sub-transistors M3a and M3b of the third transistor M3, the tenth transistor M10 and the twelfth transistor M12 may be turned off.

As a comparative example, a second node control circuit may include a fourth transistor electrically connected between a first control node and a first voltage terminal that supplies a high-level voltage, and may include a diode-connected transistor electrically connected between the first voltage terminal and a gate of the fourth transistor, instead of a second capacitor. When the second control node is at a high level, a shoot-through current flows from the first voltage terminal to a second voltage terminal through the diode-connected transistor and a fifth transistor, resulting in an increase in power consumption. In addition, the fourth transistor and a sixth transistor are turned on, causing a significant amount of current to flow from the first voltage terminal to a third voltage terminal, and the first control node is not sufficiently discharged to a third voltage. Because an N-type oxide transistor may operate in depletion mode, a current flows through pull-down transistors (for example, the tenth transistor and the twelfth transistor) of an output circuit, resulting in an increase in power consumption.

In contrast, in the second node control circuit 143 according to some example embodiments, no shoot-through current is generated at the first node P[k], and the first node P[k] may be fully discharged to the second voltage VGL1. In addition, because the second clock signal CLK2 is maintained at the third voltage VGL2, no current flows through the fourth transistor M4 and the sixth transistor M6, and thus, a voltage level of the first control node QB[k] may be stably maintained at the third voltage VGL2.

During a second period T2, the (k−1)^{th} carry signal CR[k−1] at the first voltage VGH may be supplied to the input terminal IN, the first clock signal CLK1 at the third voltage VGL2 may be supplied to the first clock terminal CK1, and the second clock signal CLK2 at the first voltage VGH may be supplied to the second clock terminal CK2.

By the first clock signal CLK1 at the third voltage VGL2, the first and second sub-transistors M1a and M1b of the first transistor M1 may be turned off, and the second control node Q[k] may be in a floating state. As the second clock signal CLK2 increases to the first voltage VGH, the voltage level of the third control node QF[k] may be boosted by coupling of the second capacitor C2 and may increase to a voltage higher than the first voltage VGH. The voltage level of the k^{th} output signal OUT[k], which did not reach the first voltage VGH during the first period T1, may be increased to the first voltage VGH during the second period T2 by the boosted voltage level of the third control node QF[k].

The voltage level of the second control node Q[k] may be maintained at a high level during the second period T2, and the second clock signal CLK2 at the first voltage VGH may be supplied to the second clock terminal CK2. Accordingly, the fifth transistor M5 and the sixth transistor M6 of the second node control circuit 143 may be maintained in a turned-on state. The second voltage VGL1 may be supplied from the second voltage terminal V2 to the first node P[k] by the turned-on fifth transistor M5. A gate-source voltage of the fourth transistor M4 may be a difference (VGL1−VGL2) between the second voltage VGL1 and the third voltage VGL2. The fourth transistor M4 may be turned on, but due to the low gate-source voltage, a very small amount of current may substantially flow through the fourth transistor M4. Therefore, power consumption of the driving circuit may be significantly reduced. The third voltage VGL2 may be supplied from the third voltage terminal V3 to the first control node QB[k] by the turned-on sixth transistor M6. Accordingly, the first and second sub-transistors M3a and M3b of the third transistor M3, the tenth transistor M10 and the twelfth transistor M12 may be turned off.

During a third period T3, the (k−1)^{th} carry signal CR[k−1] at the first voltage VGH may be supplied to the input terminal IN, the first clock signal CLK1 may be supplied to the first clock terminal CK1, and the second clock signal CLK2 may be supplied to the second clock terminal CK2. A voltage level of each of the first clock signal CLK1 and the second clock signal CLK2 may repeatedly increase and decrease between the first voltage VGH and the third voltage VGL2. For example, when the first clock signal CLK1 is supplied with the first voltage VGH and the second clock signal CLK2 is supplied with the third voltage VGL2, the voltage level of the third control node QF[k] may decrease, but may be maintained at a voltage level higher than the first voltage VGH by the turned-on first and second sub-transistors M1a and M1b of the first transistor M1 and the bootstrap of the third capacitor C3. When the first clock signal CLK1 is supplied with the third voltage VGL2 and the second clock signal CLK2 is supplied with the first voltage VGH, the voltage level of the third control node QF[k] may be boosted and increased by the charge pump circuit 144, and the voltage level of the k^{th} output signal OUT[k] may be maintained at the first voltage VGH. The second node control circuit 143 may be configured to maintain the voltage level of the first control node QB[k] at the third voltage VGL2 during the third period T3. Accordingly, the first and second sub-transistors M3a and M3b of the third transistor M3, the tenth transistor M10, and the twelfth transistor M12 may be maintained in a turned-off state.

During a fourth period T4, the (k−1)^{th} carry signal CR[k−1] at the third voltage VGL2 may be supplied to the input terminal IN, the first clock signal CLK1 at the first voltage VGH may be supplied to the first clock terminal CK1, and the second clock signal CLK2 at the third voltage VGL2 may be supplied to the second clock terminal CK2.

The first and second sub-transistors M1a and M1b of the first transistor M1 may be turned on by the first clock signal CLK1 at the first voltage VGH, and the second control node Q[k] and the third control node QF[k] may transition to the third voltage VGL2 by the turned-on first and second sub-transistors M1a and M1b of the first transistor M1. Accordingly, the second transistor M2, the eighth transistor M8, the ninth transistor M9, and the eleventh transistor M11 may be turned off.

FIG. 5B illustrates operation of the second node control circuit 143 during the fourth period T4. Referring to FIG. 5B, as the voltage level of the second control node Q[k] transitions to the third voltage VGL2 during the fourth period T4, the fifth transistor M5 and the sixth transistor M6 may be turned off. In this case, because the first node P[k] maintains the second voltage VGL1, and the second clock signal CLK2 is supplied with the third voltage VGL2, the first control node QB[k] may also maintain the third voltage VGL2 through the turned-on fourth transistor M4. Therefore, the second node control circuit 143 according to some example embodiments may be configured to stably maintain the first control node QB[k] at the third voltage VGL2 for one line time, even after the (k−1)^{th} carry signal CR[k−1] transitions to the third voltage VGL2.

Because both the first control node QB[k] and the third control node QF[k] are at the third voltage VGL2, all of the ninth transistor M9, the tenth transistor M10, the eleventh transistor M11, and the twelfth transistor M12 of the output circuit 145 are turned off, and the k^{th} carry signal CR[k], output through the carry output terminal COUT, and the k^{th} output signal OUT[k], output through the output terminal SOUT, may maintain the first voltage VGH for one line time.

During a fifth period T5, the (k−1)^{th} carry signal CR[k−1] at the third voltage VGL2 may be supplied to the input terminal IN, the first clock signal CLK1 at the third voltage VGL2 may be supplied to the first clock terminal CK1, and the second clock signal CLK2 at the first voltage VGH may be supplied to the second clock terminal CK2.

FIG. 5C illustrates operation of the second node control circuit 143 during the fifth period T5. Referring to FIG. 5C, during the fifth period T5, the voltage level of the second control node Q[k] may be maintained at the third voltage VGL2, and the second clock signal CLK2 at the first voltage VGH may be supplied to the second clock terminal CK2. Accordingly, the fifth transistor M5 and the sixth transistor M6 may be maintained in a turned-off state. A voltage level of the first node P[k] may be increased to the first voltage VGH by the first capacitor C1, and the first voltage VGH may be supplied to the first control node QB[k] by the turned-on fourth transistor M4.

Based on the voltage level of the first control node QB[k], the first and second sub-transistors M3a and M3b of the third transistor M3, the tenth transistor M10, and the twelfth transistor M12 may be turned on. The second control node Q[k] may be electrically connected to the third voltage terminal V3 through the turned-on first and second sub-transistors M3a and M3b of the third transistor M3, and the voltage level of the second control node Q[k] may be maintained at the third voltage VGL2. The carry output terminal COUT may be electrically connected to the third voltage terminal V3 by the turned-on tenth transistor M10, and the output terminal SOUT may be electrically connected to the second voltage terminal V2 by the turned-on twelfth transistor M12. Based on the voltage level of the second control node Q[k], the ninth transistor M9 and the eleventh transistor M11 may be turned off, and the voltage level of the k^{th} output signal OUT[k] may be decreased to the second voltage VGL1.

The second node control circuit 143 according to some example embodiments may prevent or reduce a shoot-through current flowing through the first node P[k], thereby significantly reducing power consumption. In addition, because the first clock signal CLK1 is supplied with the third voltage VGL2 during the first period T1 to the third period T3, and a weak current path is formed through the fourth transistor M4 only when the second clock signal CLK2 is at the first voltage VGH, power consumption may be reduced.

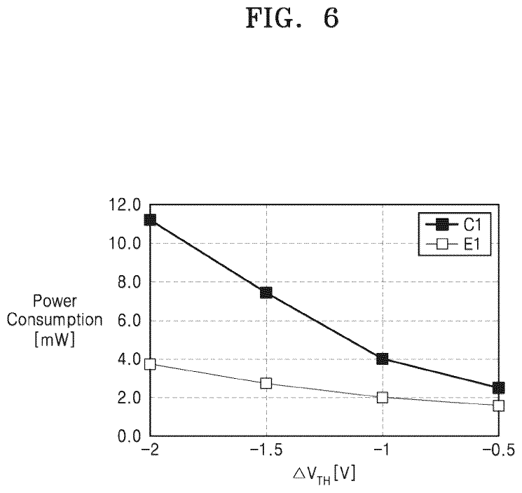

FIG. 6 is a graph illustrating power consumption of a driving circuit according to a comparative example and power consumption of a driving circuit according to some example embodiments.

FIG. 6 shows simulation results of power consumption for a driving circuit according to Comparative Example C1 and a driving circuit according to Example E1. The driving circuit according to Comparative Example C1 may include a second node control circuit in which a fourth transistor is electrically connected between a first control node and a first voltage terminal that supplies a high-level voltage, and a diode-connected transistor is electrically connected between the first voltage terminal and a gate of the fourth transistor, instead of a second capacitor. The driving circuit according to Example E1 may have the same configuration as (or a similar configuration to) that shown in FIG. 3, and the driving circuit according to Comparative Example C1 may have the same configuration (or a similar configuration) except for the second node control circuit.

Comparative Example C1 and Example E1 are composed of N-type oxide transistors that are operable in depletion mode, and an output signal line (for example, an emission control line) electrically connected to the output terminal SOUT (see FIG. 3) is set to have a resistance of 10 kΩ and a capacitance of 150 pF. The total number of stages in each driving circuit is 50, and power consumption was simulated under a condition in which both circuits have the same output waveform (or similar output waveforms).

Referring to FIG. 6, when operating in depletion mode (ΔV_{TH}=−2 V), the driving circuit according to Example E1 may reduce power consumption by up to 66% compared to the driving circuit according to Comparative Example C1.

The oxide transistors do not require a laser annealing process, allowing for lower production costs and excellent uniformity, but because they are operable in depletion mode, a significant amount of power consumption may occur. In the case of a gate driving circuit that forms a current path only for a short period, power consumption caused by depletion mode operation has little impact, but in the case of an emission control driving circuit that is required to output (or that outputs) a high-level emission control signal for a relatively long period, power consumption caused by a current flowing through a second node control circuit in depletion mode is larger. The driving circuit according to some example embodiments may significantly reduce power consumption by reducing a current flowing through the second node control circuit.

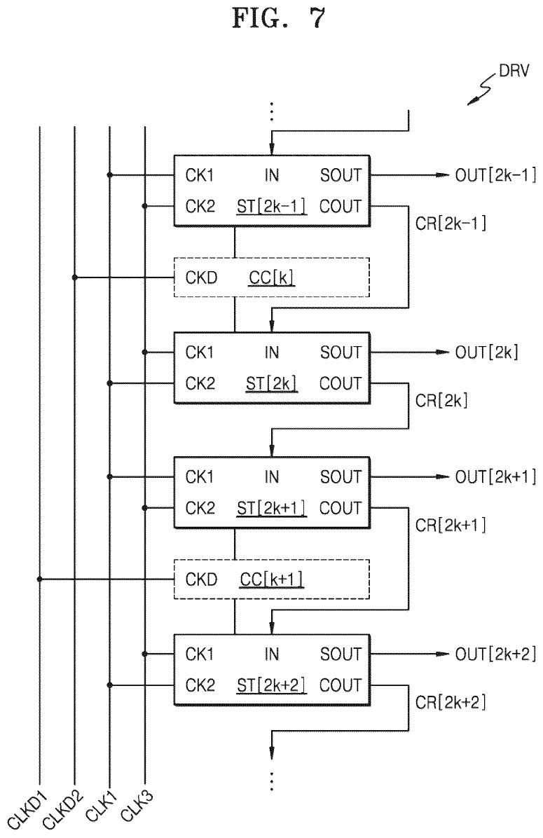

FIG. 7 is a schematic view of a driving circuit according to some example embodiments.

Referring to FIG. 7, the driving circuit DRV according to some example embodiments may include a plurality of stages ST[2k−1] to ST[2k+2] and common control circuits CC[k] and CC[k+1]. In this regard, k may be a natural number of 1 or more. FIG. 7 shows only four stages ST[2k−1] to ST[2k+2], but the driving circuit DRV may include a greater number of stages, from a first stage to an n^{th} stage.

The stages ST[2k−1] to ST[2k+2] may sequentially output output signals OUT[2k−1] to OUT[2k+2] and carry signals CR[2k−1] to CR[2k+2] to signal lines. Each of the common control circuits CC[k] and CC[k+1] may be configured to control a voltage level of a corresponding first control node of each of a consecutive odd-numbered stage and even-numbered stage (may also be referred to herein as a consecutive pair of stages), and the consecutive odd-numbered stage and even-numbered stage may share a single common control circuit. For example, the (2k−1)^{th} stage ST[2k−1] and the 2k^{th} stage ST[2k] may share the k^{th} common control circuit CC[k], and the (2k+1)^{th} stage ST[2k+1] and the (2k+2)^{th} stage ST[2k+2] may share the (k+1)^{th} common control circuit CC[k+1].

Each of the stages ST[2k−1] to ST[2k+2] may include a plurality of terminals to which or from which a plurality of signals are input or output. The plurality of signals may include a start signal, clock signals CLK1 and CLK3, and voltage signals. The plurality of terminals may include the input terminal IN, the first clock terminal CK1, the second clock terminal CK2, a voltage terminal, the output terminal SOUT, and the carry output terminal COUT.

Each of the common control circuits CC[k] and CC[k+1] may include a plurality of terminals to which a plurality of signals are input. The plurality of signals may include a start signal, double clock signals CLKD1 and CLKD2, and voltage signals. The plurality of terminals may include a double clock terminal CKD and a voltage terminal.

The start signal may be input to the input terminal IN. The stages ST[2k−1] to ST[2k+2] may respectively output the output signals OUT[2k−1] to OUT[2k+2] in response to the start signal. The start signal may be an external signal or a carry signal (hereinafter, a previous carry signal) output from a previous stage. For example, the external signal may be input as a start signal to the input terminal IN of the first stage ST[1], and a carry signal output from a previous stage may be input as a start signal to the input terminal IN of each of subsequent stages. For example, the (2k−1)^{th} carry signal CR[2k−1] output from the carry output terminal COUT of the (2k−1)^{th} stage ST[2k−1] may be input as a start signal to the input terminal IN of the 2k^{th} stage ST[2k].

The first clock signal CLK1 or the third clock signal CLK3 may be input to each of the first clock terminal CK1 and the second clock terminal CK2. According to some example embodiments, the third clock signal CLK3 may also be referred to as the second clock signal herein. In some example embodiments, the first clock signal CLK1 may be input to the first clock terminal CK1 of each of the odd-numbered stages (ST[2k−1] and ST[2k+1]), and the third clock signal CLK3 may be input to the second clock terminal CK2 of each of the odd-numbered stages (ST[2k−1] and ST[2k+1]). The the third clock signal CLK3 may be input to the first clock terminal CK1 of each of the even-numbered stages (ST[2k] and ST[2k+2]), and first clock signal CLK1 may be input to the second clock terminal CK2 of each of the even-numbered stages (ST[2k] and ST[2k+2]). In some example embodiments, the third clock signal CLK3 may be phase-shifted by a half cycle relative to the first clock signal CLK1. A half cycle of a clock signal may be one line time. In some example embodiments, the first clock signal CLK1 and the third clock signal CLK3 may be square wave signals that alternate between a high-level voltage and a low-level voltage. For example, the first clock signal CLK1 and the third clock signal CLK3 may be square wave signals that alternate between the first voltage VGH, which is a high level, and the third voltage VGL2, which is a second low level.

A first double clock signal CLKD1 or a second double clock signal CLKD2 may be input to the double clock terminal CKD. The second double clock signal CLKD2 may be input to the double clock terminal CKD of the odd-numbered common control circuit (CC[k]), and the first double clock signal CLKD1 may be input to the double clock terminal CKD of the even-numbered common control circuit (CC[k+1]). In some example embodiments, one period of the first double clock signal CLKD1 and the second double clock signal CLKD2 may be longer than one period of the first clock signal CLK1 and the third clock signal CLK3. For example, one period of the first double clock signal CLKD1 and the second double clock signal CLKD2 may be twice as long as one period of the first clock signal CLK1 and the third clock signal CLK3. In some example embodiments, the second double clock signal CLKD2 may be phase-shifted by a half cycle relative to the first double clock signal CLKD1. A half cycle of a double clock signal may be two line times. In some example embodiments, the first double clock signal CLKD1 and the second double clock signal CLKD2 may be square wave signals that alternate between a high-level voltage and a low-level voltage. For example, the first double clock signal CLKD1 and the second double clock signal CLKD2 may be square wave signals that alternate between the first voltage VGH, which is a high level, and the third voltage VGL2, which is a second low level.

Each of the stages ST[2k−1] to ST[2k+2] may output an output signal from the output terminal SOUT, in synchronization with a clock signal. The output signals OUT[2k−1] to OUT[2k+2] output from the output terminals SOUT of the stages ST[2k−1] to ST[2k+2] may be sequentially shifted by a certain period. In some example embodiments, the stages ST[2k−1] to ST[2k+2] may sequentially output the output signals OUT[2k−1] to OUT[2k+2] at a high-level voltage by shifting them by one line time.

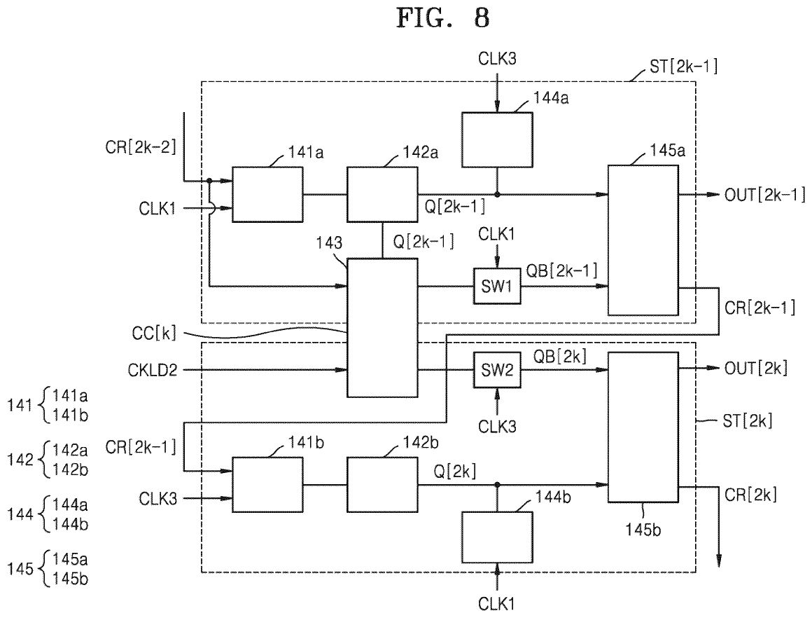

FIG. 8 is a block diagram schematically illustrating some example embodiments of two adjacent stages included in the driving circuit shown in FIG. 7.

Referring to FIG. 8, a consecutive odd-numbered stage and even-numbered stage of the driving circuit DRV may share a single common control circuit. For example, the (2k−1)^{th} stage ST[2k−1] and the 2k^{th} stage ST[2k] are the consecutive odd-numbered stage and even-numbered stage that may share the k^{th} common control circuit CC[k].

Each of the (2k−1)^{th} stage ST[2k−1] and the 2k^{th} stage ST[2k] may include the input circuit 141, the first node control circuit 142, the charge pump circuit 144, and the output circuit 145.

An input circuit 141a of the (2k−1)^{th} stage ST[2k−1] may be configured to transmit, to a second control node Q[2k−1], a start signal input to the input terminal IN, for example, a (2k−2)^{th} carry signal CR[2k−2], according to the first clock signal CLK1 input to the first clock terminal CK1. An input circuit 141b of the 2k^{th} stage ST[2k] may be configured to transmit, to a second control node Q[2k], a start signal input to the input terminal IN, for example, the (2k−1)^{th} carry signal CR[2k−1], according to the third clock signal CLK3 input to the first clock terminal CK1.

A first node control circuit 142a of the (2k−1)^{th} stage ST[2k−1] may be configured to control a voltage level of the second control node Q[2k−1], based on a voltage level of a first control node QB[2k−1]. A first node control circuit 142b of the 2k^{th} stage ST[2k] may be configured to control a voltage level of the second control node Q[2k], based on a voltage level of a first control node QB[2k].

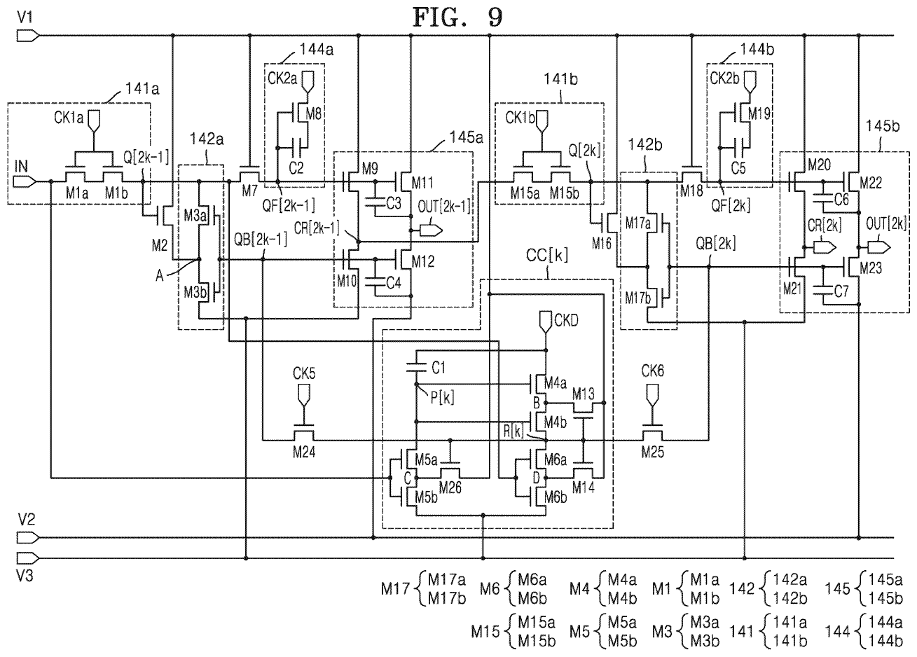

A charge pump circuit 144a of the (2k−1)^{th} stage ST[2k−1] may be configured to control a voltage level of a third control node QF[2k−1] (see FIG. 9), according to the third clock signal CLK3 input to the second clock terminal CK2. A charge pump circuit 144b of the 2k^{th} stage ST[2k] may be configured to control a voltage level of a third control node QF[2k] (see FIG. 9), according to the first clock signal CLK1 input to the second clock terminal CK2.

An output circuit 145a of the (2k−1)^{th} stage ST[2k−1] may be configured to output the (2k−1)^{th} carry signal CR[2k−1] and the (2k−1)^{th} output signal OUT[2k−1] based on the voltage level of the first control node QB[2k−1] and the voltage level of the third control node QF[2k−1] (see FIG. 9). The (2k−1)^{th} carry signal CR[2k−1] may be output to the input terminal IN of the 2k^{th} stage ST[2k]. An output circuit 145b of the 2k^{th} stage ST[2k] may be configured to output the 2k^{th} carry signal CR[2k] and the 2k^{th} output signal OUT[2k] based on the voltage level of the first control node QB[2k] and the voltage level of the third control node QF[2k].

The k^{th} common control circuit CC[k] may be the second node control circuit 143 configured to control the voltage level of the first control node QB[2k−1] of the (2k−1)^{th} stage ST[2k−1] and the voltage level of the first control node QB[2k] of the 2k^{th} stage ST[2k]. The k^{th} common control circuit CC[k] may be electrically connected to the first control node QB[2k−1] of the (2k−1)^{th} stage ST[2k−1] by a first switch transistor SW1, and may be electrically connected to the first control node QB[2k] of the 2k^{th} stage ST[2k] by a second switch transistor SW2. The first clock signal CLK1 may be input to a gate of the first switch transistor SW1, such that the first switch transistor SW1 may be configured to selectively connect the k^{th} common control circuit CC[k] to the (2k−1)^{th} stage ST[2k−1] according to the first clock signal CLK1. The third clock signal CLK3 may be input to a gate of the second switch transistor SW2, such that the second switch transistor SW2 may be configured to selectively connect the k^{th} common control circuit CC[k] to the 2k^{th} stage ST[2k] according to the third clock signal CLK3. The k^{th} common control circuit CC[k] may be alternately connected to the (2k−1)^{th} stage ST[2k−1] and the 2k^{th} stage ST[2k] according to the first clock signal CLK1 and the third clock signal CLK3.

Because two consecutive stages ST[2k−1] and ST[2k] share the second node control circuit 143 as the k^{th} common control circuit CC[k], the driving circuit DRV according to some example embodiments may have a reduced area compared to a case where each stage includes a second node control circuit. In this case, the k^{th} common control circuit CC[k] may be configured to stably maintain a voltage of each of the first control node QB[2k−1] of the (2k−1)^{th} stage ST[2k−1] and the first control node QB[2k] of the 2k^{th} stage ST[2k], by using a double clock signal having a period longer than a clock signal.

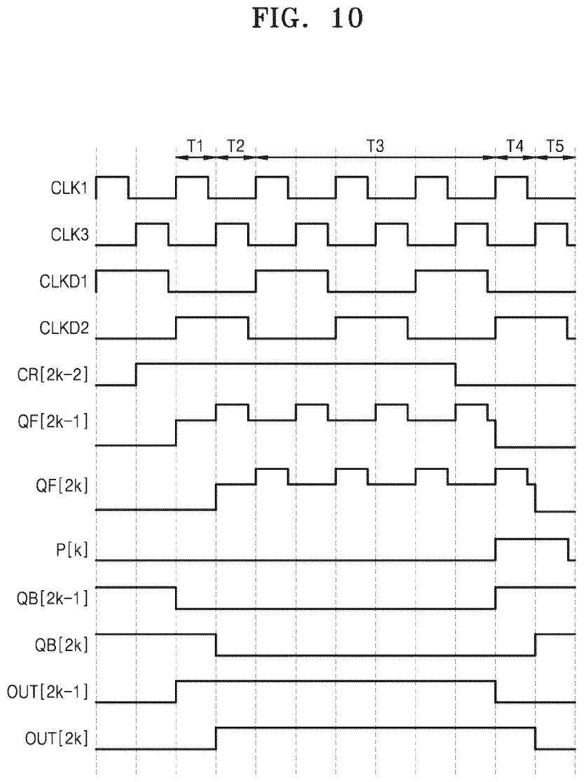

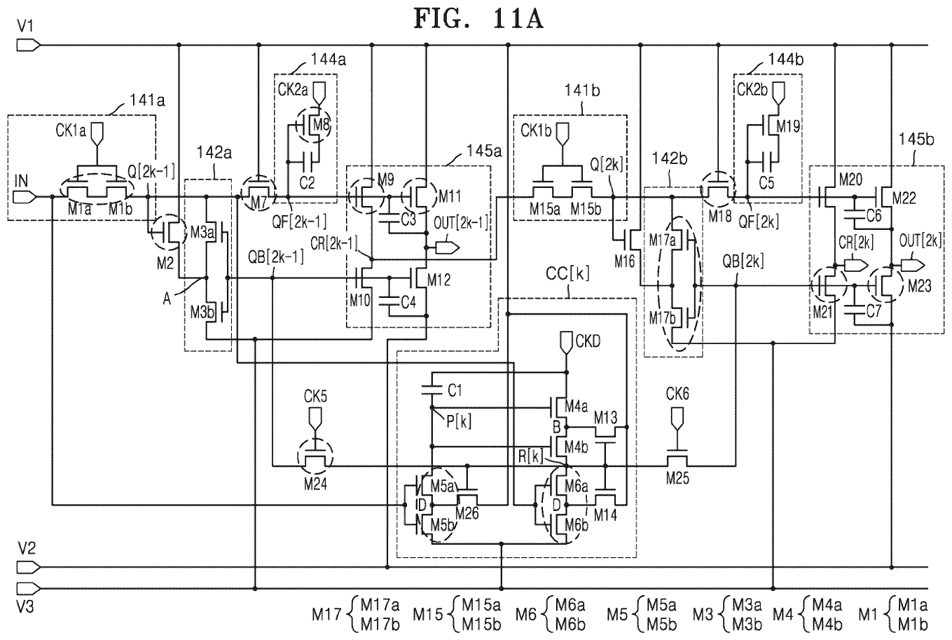

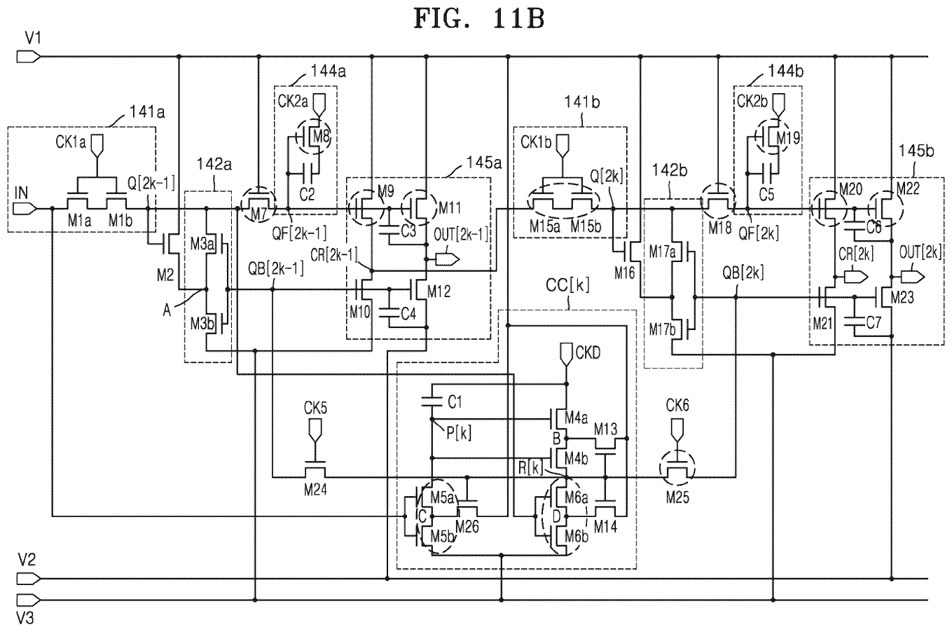

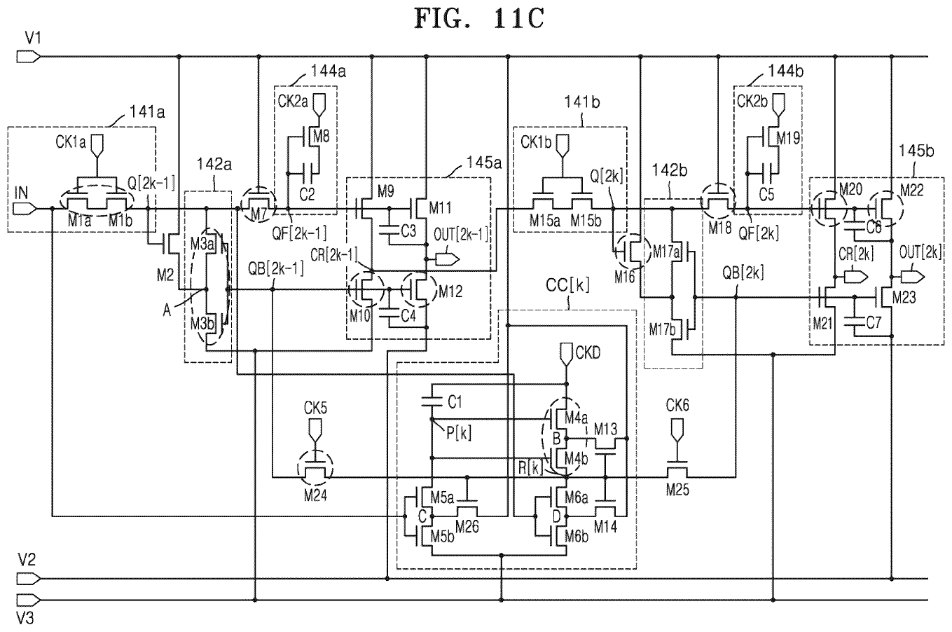

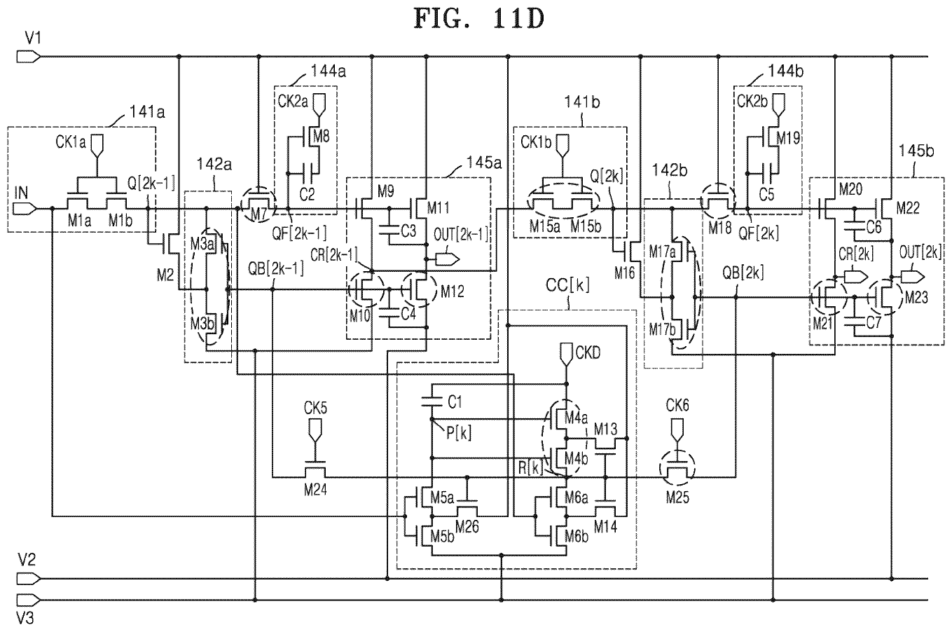

FIG. 9 is a circuit diagram schematically illustrating some example embodiments of two adjacent stages included in the driving circuit shown in FIG. 7. FIG. 10 is a timing diagram for explaining the driving of the stages of FIG. 9. FIGS. 11A to 11D are diagrams for schematically explaining operation of stages.

Referring to FIGS. 9 and 10 together, each of the (2k−1)^{th} stage ST[2k−1] and the 2k^{th} stage ST[2k] may include the input circuit 141, the first node control circuit 142, the charge pump circuit 144, and the output circuit 145. The (2k−1)^{th} stage ST[2k−1] and the 2k^{th} stage ST[2k] may share the k^{th} common control circuit CC[k] as the second node control circuit 143.

The (2k−1)^{th} stage ST[2k−1] may be connected to the input terminal IN, a first clock terminal CK1a, a second clock terminal CK2a, the first voltage terminal V1, the second voltage terminal V2, the third voltage terminal V3, a carry output terminal, and an output terminal. The 2k^{th} stage ST[2k] may be connected to an input terminal, a first clock terminal CK1b, a second clock terminal CK2b, the first voltage terminal V1, the second voltage terminal V2, the third voltage terminal V3, a carry output terminal, and an output terminal. The k^{th} common control circuit CC[k] may be connected to the double clock terminal CKD, the first voltage terminal V1, the second voltage terminal V2, and the third voltage terminal V3.

The second double clock signal CLKD2 may be input to the double clock terminal CKD of the k^{th} common control circuit CC[k]. A gate of a first switch transistor M24 configured to electrically connect the k^{th} common control circuit CC[k] to the first control node QB[2k−1] of the (2k−1)^{th} stage ST[2k−1] may be electrically connected to a third clock terminal CK5. The first clock signal CLK1 may be input to the third clock terminal CK5. A gate of a second switch transistor M25 configured to electrically connect the k^{th} common control circuit CC[k] to the first control node QB[2k] of the 2k^{th} stage ST[2k] may be electrically connected to a fourth clock terminal CK6. The third clock signal CLK3 may be input to the fourth clock terminal CK6.

The (2k−2)^{th} carry signal CR[2k−2] may be input to the input terminal IN of the (2k−1)^{th} stage ST[2k−1], the first clock signal CLK1 may be input to the first clock terminal CK1a, and the third clock signal CLK3 may be input to the second clock terminal CK2a. The (2k−1)^{th} carry signal CR[2k−1] may be input to the input terminal IN of the 2k^{th} stage ST[2k], the third clock signal CLK3 may be input to the first clock terminal CK1b, and the first clock signal CLK1 may be input to the second clock terminal CK2b. The (2k−1)^{th} carry signal CR[2k−1] may be output to the carry output terminal of the (2k−1)^{th} stage ST[2k−1], and the (2k−1)^{th} output signal OUT[2k−1] may be output to the output terminal of the (2k−1)^{th} stage ST[2k−1]. The 2k^{th} carry signal CR[2k] may be output to the carry output terminal of the 2k^{th} stage ST[2k], and the 2k^{th} output signal OUT[2k] may be output to the output terminal of the 2k^{th} stage ST[2k]. The first voltage VGH, which is a high-level voltage, may be supplied to the first voltage terminal V1, the second voltage VGL1, which is a first low level voltage, may be supplied to the second voltage terminal V2, and the third voltage VGL2, which is a second low level voltage, may be supplied to the third voltage terminal V3. A voltage level of the third voltage VGL2 may be lower than a voltage level of the second voltage VGL1.

Each of the (2k−1)^{th} stage ST[2k−1] and the 2k^{th} stage ST[2k] may include a plurality of transistors and a plurality of capacitors. In some example embodiments, the transistors may be N-type transistors. A gate-on voltage of an N-type transistor may be a high-level voltage, and a gate-off voltage thereof may be a low-level voltage. In some example embodiments, the transistors may be P-type transistors. A gate-on voltage of a P-type transistor may be a low-level voltage, and a gate-off voltage thereof may be a high-level voltage.

Depending on the type (p-type or n-type) of transistor and/or operating conditions, a first terminal of each of the transistors may be either a source or a drain, and a second terminal thereof may be different from the first terminal. For example, when the first terminal is a source, the second terminal may be a drain.

The (2k−1)^{th} stage ST[2k−1] and the 2k^{th} stage ST[2k] may have substantially the same or similar configuration. For example, transistors M1, M2, . . . , and M12 included in the (2k−1)^{th} stage ST[2k−1] may respectively correspond to transistors M15, M16, . . . , and M23 included in the 2k^{th} stage ST[2k], and capacitors C2, C3, and C4 included in the (2k−1)^{th} stage ST[2k−1] may respectively correspond to capacitors C5, C6, and C7 included in the 2k^{th} stage ST[2k]. Hereinafter, connection relationships of components are described, mainly with respect to the (2k−1)^{th} stage ST[2k−1].

The input circuit 141a may include a gate electrically connected to the first clock terminal CK1a, and may include the first and second sub-transistors M1a and M1b of the first transistor M1 electrically connected between the input terminal IN and the second control node Q[2k−1]. The first transistor M1 may include the two sub-transistors M1a and M1b connected in series.

The first node control circuit 142a may include a gate electrically connected to the first control node QB[2k−1], and may include the first and second sub-transistors M3a and M3b of the third transistor M3 electrically connected between the second control node Q[2k−1] and the third voltage terminal V3. The third transistor M3 may include the two sub-transistors M3a and M3b connected in series. The second terminal of the first sub-transistor M3a of the third transistor M3 and the first terminal of the second sub-transistor M3b may be electrically connected to the first sub-node A. The second transistor M2 may include a gate electrically connected to the second control node Q[2k−1] and may be electrically connected between the first voltage terminal V1 and the first sub-node A. The second transistor M2 may be turned on when a voltage level of the second control node Q[2k−1] is a high level, and may be configured to transmit the first voltage VGH to the first sub-node A.

The charge pump circuit 144a may include a gate electrically connected to the third control node QF[2k−1], and may include the second capacitor C2 and the eighth transistor M8 electrically connected between the second clock terminal CK2a and the second capacitor C2. The second capacitor C2 may be electrically connected between the eighth transistor M8 and the third control node QF[2k−1].

The seventh transistor M7 may include a gate electrically connected to the first voltage terminal V1, and may be electrically connected between the second control node Q[2k−1] and the third control node QF[2k−1].

The output circuit 145a may include the ninth transistor M9, the tenth transistor M10, the eleventh transistor M11, the twelfth transistor M12, the third capacitor C3, and the fourth capacitor C4. The ninth transistor M9 may include a gate electrically connected to the third control node QF[2k−1], and may be electrically connected between the first voltage terminal V1 and the carry output terminal. The tenth transistor M10 may include a gate electrically connected to the first control node QB[2k−1], and may be electrically connected between the third voltage terminal V3 and the carry output terminal. The eleventh transistor M11 may include a gate electrically connected to the third control node QF[2k−1], and may be electrically connected between the first voltage terminal V1 and the output terminal. The twelfth transistor M12 may include a gate electrically connected to the first control node QB[2k−1], and may be electrically connected between the second voltage terminal V2 and the output terminal. The third capacitor C3 may be electrically connected between the gate of the eleventh transistor M11 and the output terminal. The fourth capacitor C4 may be electrically connected between the gate of the twelfth transistor M12 and the second voltage terminal V2.

The k^{th} common control circuit CC[k] may include sub-transistors M4a and M4b of the fourth transistor M4, sub-transistors M5a and M5b of the fifth transistor M5, sub-transistors M6a and M6b of the sixth transistor M6, and the first capacitor C1. The sub-transistors M4a and M4b of the fourth transistor M4 include gates electrically connected to the first node P[k], and may be electrically connected between the double clock terminal CKD and a second node R[k]. The sub-transistors M5a and M5b of the fifth transistor M5 may include gates electrically connected to the input terminal IN of the (2k−1)^{th} stage ST[2k−1], and may be electrically connected between the first node P[k] and the third voltage terminal V3. The sub-transistors M6a and M6b of the sixth transistor M6 may include gates electrically connected to the second control node Q[2k−1], and may be electrically connected between the second node R[k] and the third voltage terminal V3.

In some example embodiments, each of the fourth transistor M4, the fifth transistor M5, and the sixth transistor M6 may include two sub-transistors connected in series with each other. A point at which the sub-transistors M4a and M4b of the fourth transistor M4 are connected to each other may be referred as a second sub-node B, a point at which the sub-transistors M5a and M5b of the fifth transistor M5 are connected to each other may be referred as a third sub-node C, and a point where the sub-transistors M6a and M6b of the sixth transistor M6 are connected to each other may be referred as a fourth sub-node D. The kth common control circuit CC[k] may further include a thirteenth transistor M13, a fourteenth transistor M14, and a twenty-sixth transistor M26. The thirteenth transistor M13 may include a gate electrically connected to the second node R[k], and may be electrically connected between the second sub-node B and the first voltage terminal V1. The fourteenth transistor M14 may include a gate electrically connected to the second node R[k], and may be electrically connected between the fourth sub-node D and the first voltage terminal V1. The twenty-sixth transistor M26 may include a gate electrically connected to the second node R[k], and may be electrically connected between the third sub-node C and the first voltage terminal V1. The thirteenth transistor M13, the fourteenth transistor M14, and the twenty-sixth transistor M26 may be turned on when the second node R[k] is at a high-level voltage, and may thus be configured to supply the first voltage VGH from the first voltage terminal V1 to the second sub-node B, the third sub-node C, and the fourth sub-node D. In some example embodiments, the fourth transistor M4, the fifth transistor M5, and the sixth transistor M6 may each be provided as a single transistor, and the thirteenth transistor M13, the fourteenth transistor M14, and the twenty-sixth transistor M26 may be omitted.

The first switch transistor M24 may include a gate electrically connected to the third clock terminal CK5, and may be electrically connected between the first control node QB[2k−1] of the (2k−1)^{th} stage ST[2k−1] and the second node R[k] of the k^{th} common control circuit CC[k]. The second switch transistor M25 may include a gate electrically connected to the fourth clock terminal CK6, and may be electrically connected between the first control node QB[2k] of the 2k^{th} stage ST[2k] and the second node R[k] of the k^{th} common control circuit CC[k]. The first clock signal CLK1 may be input to the third clock terminal CK5, and the third clock signal CLK3 may be input to the fourth clock terminal CK6.

FIG. 10 shows the first clock signal CLK1, the third clock signal CLK3, the (2k−2)^{th} carry signal CR[2k−2], a voltage level of each of the first control node QB[2k−1] and the third control node QF[2k−1] of the (2k−1)^{th} stage ST[2k−1] and the first control node QB[2k] of the 2k^{th} stage ST[2k], the (2k−1)^{th} output signal OUT[2k−1], and the 2k^{th} output signal OUT[2k]. Except that the external signal FLM is input as a start signal to the input terminal IN, the first stage ST[1] may operate in the same manner or a similar manner as described below.

FIG. 11A illustrates transistors to which a gate-on voltage is applied to gates during the first period T1 in the (2k−1)^{th} stage ST[2k−1], the 2k^{th} stage ST[2k], and the k^{th} common control circuit CC[k]. During the first period T1, the (2k−2)^{th} carry signal CR[2k−2] at the first voltage VGH may be supplied to the input terminal IN of the (2k−1)^{th} stage ST[2k−1], the first clock signal CLK1 at the first voltage VGH may be supplied to the first clock terminal CK1a, and the third clock signal CLK3 at the third voltage VGL2 may be supplied to the second clock terminal CK2a. The (2k−1)^{th} carry signal CR[2k−1] at the first voltage VGH may be supplied to the input terminal IN of the 2k^{th} stage ST[2k], the third clock signal CLK3 at the third voltage VGL2 may be supplied to the first clock terminal CK1b, and the first clock signal CLK1 at the first voltage VGH may be supplied to the second clock terminal CK2b.

First, in the (2k−1)^{th} stage ST[2k−1], the sub-transistors M1a and M1b of the first transistor M1 may be turned on by the first clock signal CLK1 at the first voltage VGH. The (2k−2)^{th} carry signal CR[2−2] at the first voltage VGH may be transmitted to the second control node Q[2k−1] by the turned on sub-transistors M1a and M1b of the first transistor M1, and a voltage level of each of the second control node Q[2k−1] and the third control node QF[2k−1] may transition from a low level to a high level. Accordingly, the second transistor M2, the ninth transistor M9, and the eleventh transistor M11 may be turned on. The first voltage terminal V1 and the first sub-node A may be electrically connected to each other by the turned-on second transistor M2, and the first voltage VGH may be supplied to the first sub-node A. A voltage level of the (2k−1)^{th} carry signal CR[2k−1] may be increased to the first voltage VGH by the turned-on ninth transistor M9. A voltage level of the (2k−1)^{th} output signal OUT[2k−1] may be increased to the first voltage VGH by the turned-on eleventh transistor M11. As the voltage level of the (2k−1)^{th} output signal OUT[2k−1] increases from a low level to a high level, the voltage level of the third control node QF[2k−1] may be bootstrapped to a voltage level higher than the first voltage VGH by coupling of the third capacitor C3.

The second double clock signal CLKD2 at the first voltage VGH may be input to the double clock terminal CKD of the k^{th} common control circuit CC[k]. The (2k−2)^{th} carry signal CR[2k−2] at the first voltage VGH may be input to the gates of the sub-transistors M5a and M5b of the fifth transistor M5, and the sub-transistors M5a and M5b of the fifth transistor M5 may be turned on such that the third voltage VGL2 may be supplied to the first node P[k]. According to a voltage level of the first node P[k], the sub-transistors M4a and M4b of the fourth transistor M4 may be turned off. According to the voltage level of the second control node Q[2k−1], which is a high level, the sub-transistors M6a and M6b of the sixth transistor M6 may be turned on, and the third voltage VGL2 may be supplied to the second node R[k]. According to the first clock signal CLK1 at the first voltage VGH, which is input to the third clock terminal CK5, the first switch transistor M24 may be turned on. According to the third clock signal CLK3 at the third voltage VGL2, which is input to the fourth clock terminal CK6, the second switch transistor M25 may be turned off. The second node R[k] of the k^{th} common control circuit CC[k] and the first control node QB[2k−1] of the (2k−1)^{th} stage ST[2k−1] may be electrically connected to each other through the turned-on first switch transistor M24, and the first control node QB[2k−1] of the (2k−1)^{th} stage ST[2k−1] may be discharged to the third voltage VGL2.

In the 2k^{th} stage ST[2k], sub-transistors M15a and M15b of the fifteenth transistor M15 may be turned off by the third clock signal CLK3 at the third voltage VGL2. Because the second switch transistor M25 is in a turned-off state, the first control node QB[2k] may be maintained at a high-level voltage, and sub-transistors M17a and M17b of the seventeenth transistor M17, the twenty-first transistor M21, and the twenty-third transistor M23 may be turned on. The 2k^{th} carry signal CR[2k] may be maintained at the third voltage VGL2 by the turned-on twenty-first transistor M21, and the 2k^{th} output signal OUT[2k] may be maintained at the second voltage VGL1 by the turned-on twenty-third transistor M23.

FIG. 11B illustrates transistors to which a gate-on voltage is applied to gates during the second period T2 in the (2k−1)^{th} stage ST[2k−1], the 2k^{th} stage ST[2k], and the k^{th} common control circuit CC[k]. During the second period T2, the (2k−2)^{th} carry signal CR[2−2] at the first voltage VGH may be supplied to the input terminal IN of the (2k−1)^{th} stage ST[2k−1], the first clock signal CLK1 at the third voltage VGL2 may be supplied to the first clock terminal CK1a, and the third clock signal CLK3 at the first voltage VGH may be supplied to the second clock terminal CK2a. The (2k−1)^{th} carry signal CR[2k−1] at the first voltage VGH may be supplied to the input terminal IN of the 2k^{th} stage ST[2k], the third clock signal CLK3 at the first voltage VGH may be supplied to the first clock terminal CK1b, and the first clock signal CLK1 at the third voltage VGL2 may be supplied to the second clock terminal CK2b.

In the (2k−1)^{th} stage ST[2k−1], the sub-transistors M1a and M1b of the first transistor M1 may be turned off by the first clock signal CLK1 at the third voltage VGL2, and the second control node Q[2k−1] may be in a floating state. As the third clock signal CLK3 increases to the first voltage VGH, the voltage level of the third control node QF[2k−1] may be boosted by coupling of the second capacitor C2 and may increase to a voltage higher than the first voltage VGH. According to the voltage level of the third control node QF[2k−1], the ninth transistor M9 and the eleventh transistor M11 may be maintained in a turned-on state.

The second double clock signal CLKD2 at the first voltage VGH may be input to the double clock terminal CKD of the k^{th} common control circuit CC[k]. The (2k−2)^{th} carry signal CR[2k−2] at the first voltage VGH may be input to the gates of the sub-transistors M5a and M5b of the fifth transistor M5, and the sub-transistors M5a and M5b of the fifth transistor M5 may be turned on such that the third voltage VGL2 may be supplied to the first node P[k]. According to the voltage level of the first node P[k], the sub-transistors M4a and M4b of the fourth transistor M4 may be turned off. According to the voltage level of the second control node Q[2k−1], which is a high level, the sub-transistors M6a and M6b of the sixth transistor M6 may be turned on, and the third voltage VGL2 may be supplied to the second node R[k].

The first switch transistor M24 may be turned off by the first clock signal CLK1 at the third voltage VGL2, and the second switch transistor M25 may be turned on by the third clock signal CLK3 at the first voltage VGH. By the turned-on second switch transistor M25, the second node R[k] of the k^{th} common control circuit CC[k] may be electrically connected to the first control node QB[2k] of the 2k^{th} stage ST[2k]. The first control node QB[2k] of the 2k^{th} stage ST[2k] may be discharged to the third voltage VGL2.

In the 2k^{th} stage ST[2k], the sub-transistors M15a and M15b of the fifteenth transistor M15 may be turned on by the third clock signal CLK3 at the first voltage VGH. The (2k−1)^{th} carry signal CR[2k−1] at the first voltage VGH may be transmitted to the second control node Q[2k] by the output circuit 145a of the (2k−1)^{th} stage ST[2k−1], and a voltage level of each of the second control node Q[2k] and the third control node QF[2k] may transition from a low level to a high level. Accordingly, the sixteenth transistor M16, the twentieth transistor M20, and the twenty-second transistor M22 may be turned on. The 2k^{th} carry signal CR[2k] may transition to the first voltage VGH by the turned-on twentieth transistor M20, and the 2k^{th} output signal OUT[2k] may transition to the first voltage VGH by the turned-on twenty-second transistor M22. As a voltage level of the 2k^{th} output signal OUT[2k] increases from a low level to a high level, the voltage level of the third control node QF[2k] may be bootstrapped to a voltage level higher than the first voltage VGH by coupling of the sixth capacitor C6.

During the third period T3, a voltage level of each of the first clock signal CLK1 and the third clock signal CLK3 may repeatedly increase and decrease between the first voltage VGH and the third voltage VGL2. The first control node QB[2k−1] and the first control node QB[2k] may be maintained at the third voltage VGL2 during the third period T3. The voltage levels of third control node QF[2k−1] and the third control node QF[2k] may repeatedly rise and fall, but may be maintained at a voltage level higher than the first voltage VGH. The (2k−1)^{th} output signal OUT[2k−1] and the 2k^{th} output signal OUT[2k] may be maintained at the first voltage VGH.

FIG. 11C illustrates transistors to which a gate-on voltage is applied to gates during the fourth period T4 in the (2k−1)^{th} stage ST[2k−1], the 2k^{th} stage ST[2k], and the k^{th} common control circuit CC[k]. During the fourth period T4, the (2k−2)^{th} carry signal CR[2k−2] at the third voltage VGL2 may be supplied to the input terminal IN of the (2k−1)^{th} stage ST[2k−1], the first clock signal CLK1 at the first voltage VGH may be supplied to the first clock terminal CK1a, and the third clock signal CLK3 at the third voltage VGL2 may be supplied to the second clock terminal CK2a. The (2k−1)^{th} carry signal CR[2k−1] at the third voltage VGL2 may be supplied to the input terminal IN of the 2k^{th} stage ST[2k], the third clock signal CLK3 at the third voltage VGL2 may be supplied to the first clock terminal CK1b, and the first clock signal CLK1 at the first voltage VGH may be supplied to the second clock terminal CK2b.

In the (2k−1)^{th} stage ST[2k−1], the sub-transistors M1a and M1b of the first transistor M1 may be turned on by the first clock signal CLK1 at the first voltage VGH. The (2k−2)^{th} carry signal CR[2k−2] at the third voltage VGL2 may be transmitted to the second control node Q[2k−1] by the turned on sub-transistors M1a and M1b of the first transistor M1, and the voltage level of each of the second control node Q[2k−1] and the third control node QF[2k−1] may transition to the third voltage VGL2. Accordingly, the second transistor M2, the ninth transistor M9, and the eleventh transistor M11 may be turned off.

The second double clock signal CLKD2 at the first voltage VGH may be input to the double clock terminal CKD of the k^{th} common control circuit CC[k]. The (2k−2)^{th} carry signal CR[2k−2] at the third voltage VGL2 may be input to the gates of the sub-transistors M5a and M5b of the fifth transistor M5, and the sub-transistors M5a and M5b of the fifth transistor M5 may be turned off. According to the voltage level of the second control node Q[2k−1], the sub-transistors M6a and M6b of the sixth transistor M6 may be turned off. The voltage level of the first node P[k] may transition to a high level, and the sub-transistors M4a and M4b of the fourth transistor M4 may be turned on according to the voltage level of the first node P[k]. The second double clock signal CLKD2 at the first voltage VGH may be supplied to the second node R[k] through the turned-on fourth transistor M4.

According to the first clock signal CLK1 at the first voltage VGH, the first switch transistor M24 may be turned on, the second node R[k] of the k^{th} common control circuit CC[k] and the first control node QB[2k−1] of the (2k−1)^{th} stage ST[2k−1] may be electrically connected to each other through the turned-on first switch transistor M24, and the first control node QB[2k−1] of the (2k−1)^{th} stage ST[2k−1] may transition to the first voltage VGH.

According to the first voltage VGH of the first control node QB[2k−1] of the (2k−1)^{th} stage ST[2k−1], the sub-transistors M3a and M3b of the third transistor M3, the tenth transistor M10, and the twelfth transistor M12 may be turned on. The third voltage terminal V3 and the second control node Q[2k−1] may be electrically connected to each other through the turned-on sub-transistors M3a and M3b of the third transistor M3, and the second control node Q[2k−1] may be discharged to the third voltage VGL2. The (2k−1)^{th} carry signal CR[2k−1] may transition to the third voltage VGL2 through the turned-on tenth transistor M10, and the (2k−1)^{th} output signal OUT[2k−1] may transition to the second voltage VGL1 through the turned-on twelfth transistor M12.

According to the third clock signal CLK3 at the third voltage VGL2, the second switch transistor M25 may be turned off, and the first control node QB[2k] of the 2k^{th} stage ST[2k] may be maintained at the third voltage VGL2. In the 2k^{th} stage ST[2k], the sub-transistors M15a and M15b of the fifteenth transistor M15 may be turned off by the third clock signal CLK3 at the third voltage VGL2. Accordingly, the second control node Q[2k] may be maintained at the first voltage VGH in a floating state. According to the voltage level of the second control node Q[2k], the twentieth transistor M20 and the twenty-second transistor M22 may be maintained in a turned-on state. The 2k^{th} carry signal CR[2k] may maintain the first voltage VGH by the turned-on twentieth transistor M20, and the 2k^{th} output signal OUT[2k] may further maintain the first voltage VGH for one line time by the turned-on twenty-second transistor M22.

FIG. 11D illustrates transistors to which a gate-on voltage is applied to gates during the fifth period T5 in the (2k−1)^{th} stage ST[2k−1], the 2k^{th} stage ST[2k], and the k^{th} common control circuit CC[k]. During the fifth period T5, the (2k−2)^{th} carry signal CR[2k−2] at the third voltage VGL2 may be supplied to the input terminal IN of the (2k−1)^{th} stage ST[2k−1], the first clock signal CLK1 at the third voltage VGL2 may be supplied to the first clock terminal CK1a, and the third clock signal CLK3 at the first voltage VGH may be supplied to the second clock terminal CK2a. The (2k−1)^{th} carry signal CR[2k−1] at the third voltage VGL2 may be supplied to the input terminal IN of the 2k^{th} stage ST[2k], the third clock signal CLK3 at the first voltage VGH may be supplied to the first clock terminal CK1b, and the first clock signal CLK1 at the third voltage VGL2 may be supplied to the second clock terminal CK2b.

In the (2k−1)^{th} stage ST[2k−1], the sub-transistors M1a and M1b of the first transistor M1 may be turned off by the first clock signal CLK1 at the third voltage VGL2. The voltage level of the second control node Q[2k−1] may be maintained at the third voltage VGL2, and the second transistor M2, the ninth transistor M9, and the eleventh transistor M11 may be turned off.

The second double clock signal CLKD2 at the first voltage VGH may be input to the double clock terminal CKD of the k^{th} common control circuit CC[k]. The (2k−2)^{th} carry signal CR[2k−2] at the third voltage VGL2 may be input to the gates of the sub-transistors M5a and M5b of the fifth transistor M5, and the sub-transistors M5a and M5b of the fifth transistor M5 may be maintained in a turned-off state. The voltage level of the first node P[k] may transition to a high level, and the sub-transistors M4a and M4b of the fourth transistor M4 may be turned on according to the voltage level of the first node P[k]. The second double clock signal CLKD2 at the first voltage VGH may be supplied to the second node R[k] through the turned-on fourth transistor M4.

According to the first clock signal CLK1 at the third voltage VGL2, the first switch transistor M24 may be turned off, and the first control node QB[2k−1] of the (2k−1)^{th} stage ST[2k−1] may maintain the first voltage VGH in a floating state. According to the voltage level of the first control node QB[2k−1] of the (2k−1)^{th} stage ST[2k−1], the sub-transistors M3a and M3b of the third transistor M3, the tenth transistor M10, and the twelfth transistor M12 may be turned on. The third voltage terminal V3 and the second control node Q[2k−1] may be electrically connected to each other through the turned-on sub-transistors M3a and M3b of the third transistor M3, and the second control node Q[2k−1] may be discharged to the third voltage VGL2. The (2k−1)^{th} carry signal CR[2k−1] may transition to the third voltage VGL2 through the turned-on tenth transistor M10, and the (2k−1)^{th} output signal OUT[2k−1] may transition to the second voltage VGL1 through the turned-on twelfth transistor M12.

According to the third clock signal CLK3 at the first voltage VGH, the second switch transistor M25 may be turned on, and the first control node QB[2k] of the 2k^{th} stage ST[2k] may transition to the first voltage VGH.

In the 2k^{th} stage ST[2k], the sub-transistors M15a and M15b of the fifteenth transistor M15 may be turned on by the third clock signal CLK3 at the first voltage VGH. Therefore, the (2k−1)^{th} carry signal CR[2k−1] at the third voltage VGL2 may be supplied to the second control node Q[2k], and the voltage level of each of the second control node Q[2k] and the third control node QF[2k] may transition to the third voltage VGL2. According to the voltage level of the third control node QF[2k], the sixteenth transistor M16, the twentieth transistor M20, and the twenty-second transistor M22 may be turned off. According to the voltage level of the first control node QB[2k], the sub-transistors M17a and M17b of the seventeenth transistor M17, the twenty-first transistor M21, and the twenty-third transistor M23 may be turned on. The third voltage terminal V3 and the second control node Q[2k] may be electrically connected to each other through the turned-on sub-transistors M17a and M17b of the seventeenth transistor M17, and the second control node Q[2k] may be discharged to the third voltage VGL2. The 2k^{th} carry signal CR[2k] may transition to the third voltage VGL2 through the turned-on twenty-first transistor M21, and the 2k^{th} output signal OUT[2k] may transition to the second voltage VGL1 through the turned-on twenty-third transistor M23.

When the driving circuit DRV is an emission control driving circuit having a long on-voltage period of an output signal, power consumption of a node control circuit configured to control a voltage level of a first control node may be relatively large. In particular, when transistors included in the driving circuit DRV are oxide transistors, power consumption may further increase due to operation in depletion mode. The driving circuit DRV according to some example embodiments may be configured to control the voltage level of the first control node QB[2k−1] of the (2k−1)^{th} stage ST[2k−1] and the voltage level of the first control node QB[2k] of the 2k^{th} stage ST[2k] through the k^{th} common control circuit CC[k]. Therefore, power consumption may be significantly reduced.

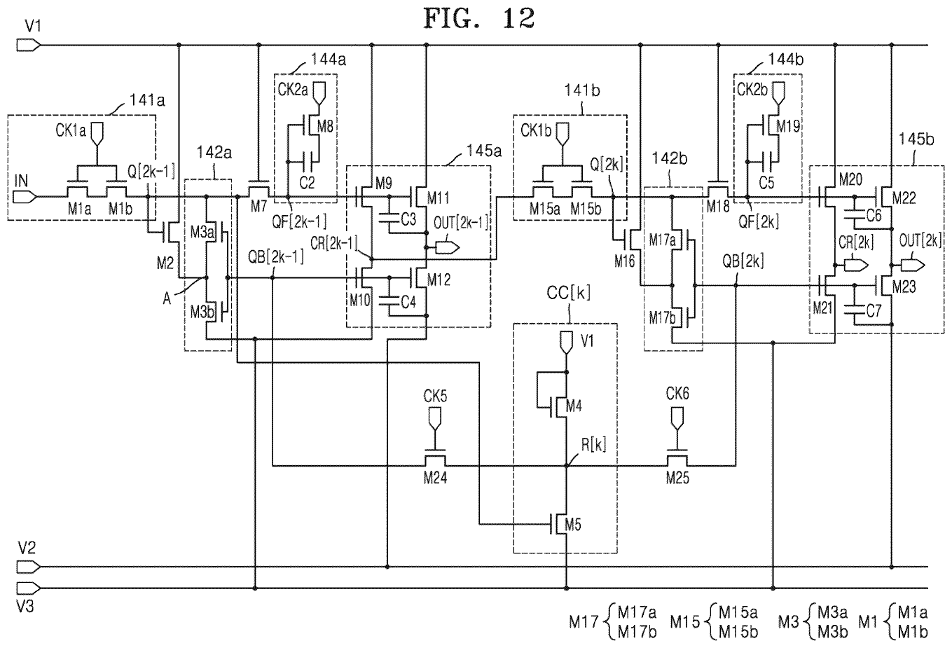

FIG. 12 is a circuit diagram schematically illustrating some example embodiments of two adjacent stages included in a driving circuit according to some example embodiments.

Referring to FIG. 12, each of the (2k−1)^{th} stage ST[2k−1] and the 2k^{th} stage ST[2k] may include the input circuit 141, the first node control circuit 142, the charge pump circuit 144, and the output circuit 145. The (2k−1)^{th} stage ST[2k−1] and the 2k^{th} stage ST[2k] may share the k^{th} common control circuit CC[k] as the second node control circuit 143.

The (2k−1)^{th} stage ST[2k−1] may be connected to the input terminal IN, the first clock terminal CK1a, the second clock terminal CK2a, the first voltage terminal V1, the second voltage terminal V2, the third voltage terminal V3, a carry output terminal, and an output terminal. The 2k^{th} stage ST[2k] may be connected to an input terminal, the first clock terminal CK1b, the second clock terminal CK2b, the first voltage terminal V1, the second voltage terminal V2, the third voltage terminal V3, a carry output terminal, and an output terminal. The k^{th} common control circuit CC[k] may be connected to the first voltage terminal V1, and the third voltage terminal V3. The gate of the first switch transistor M24 configured to electrically connect the k^{th} common control circuit CC[k] to the first control node QB[2k−1] of the (2k−1)^{th} stage ST[2k−1] may be electrically connected to the third clock terminal CK5. The first clock signal CLK1 may be input to the third clock terminal CK5. The gate of the second switch transistor M25 configured to electrically connect the k^{th} common control circuit CC[k] to the first control node QB[2k] of the 2k^{th} stage ST[2k] may be electrically connected to the fourth clock terminal CK6. The third clock signal CLK3 may be input to the fourth clock terminal CK6.

The (2k−2)^{th} carry signal CR[2k−2] may be input to the input terminal IN of the (2k−1)^{th} stage ST[2k−1], the first clock signal CLK1 may be input to the first clock terminal CK1a, and the third clock signal CLK3 may be input to the second clock terminal CK2a. The (2k−1)^{th} carry signal CR[2k−1] may be input to the input terminal IN of the 2k^{th} stage ST[2k], the third clock signal CLK3 may be input to the first clock terminal CK1b, and the first clock signal CLK1 may be input to the second clock terminal CK2b. The (2k−1)^{th} carry signal CR[2k−1] may be output to the carry output terminal of the (2k−1)^{th} stage ST[2k−1], and the (2k−1)^{th} output signal OUT[2k−1] may be output to the output terminal of the (2k−1)^{th} stage ST[2k−1]. The 2k^{th} carry signal CR[2k] may be output to the carry output terminal of the 2k^{th} stage ST[2k], and the 2k^{th} output signal OUT[2k] may be output to the output terminal of the 2k^{th} stage ST[2k]. The first voltage VGH, which is a high-level voltage, may be supplied to the first voltage terminal V1, the second voltage VGL1, which is a first low level voltage, may be supplied to the second voltage terminal V2, and the third voltage VGL2, which is a second low level voltage, may be supplied to the third voltage terminal V3. A voltage level of the third voltage VGL2 may be lower than a voltage level of the second voltage VGL1.

Each of the (2k−1)^{th} stage ST[2k−1] and the 2k^{th} stage ST[2k] may include a plurality of transistors and a plurality of capacitors. In some example embodiments, the transistors may be N-type transistors.

The (2k−1)^{th} stage ST[2k−1] and the 2k^{th} stage ST[2k] may have substantially the same or similar configuration. For example, the transistors M1, M2, . . . , and M12 included in the (2k−1)^{th} stage ST[2k−1] may respectively correspond to the transistors M15, M16, . . . , and M23 included in the 2k^{th} stage ST[2k], and the capacitors C2, C3, and C4 included in the (2k−1)^{th} stage ST[2k−1] may respectively correspond to the capacitors C5, C6, and C7 included in the 2k^{th} stage ST[2k]. The (2k−1)^{th} stage ST[2k−1] and the 2k^{th} stage ST[2k] shown in FIG. 12 are substantially the same as the (2k−1)^{th} stage ST[2k−1] and the 2k^{th} stage ST[2k] shown in FIG. 9, and thus, hereinafter, descriptions of the same and similar configuration are omitted.

The k^{th} common control circuit CC[k] may include the fourth transistor M4 and the fifth transistor M5. The fourth transistor M4 may be diode-connected, and the first terminal and gate of the fourth transistor M4 may be electrically connected to the first voltage terminal V1, and the second terminal thereof may be electrically connected to the second node R[k]. The fifth transistor M5 may be connected between the second node R[k] and the third voltage terminal V3. The first switch transistor M24 may include a gate electrically connected to the third clock terminal CK5, and may be electrically connected between the first control node QB[2k−1] of the (2k−1)^{th} stage ST[2k−1] and the second node R[k] of the k^{th} common control circuit CC[k]. The second switch transistor M25 may include a gate electrically connected to the fourth clock terminal CK6, and may be electrically connected between the first control node QB[2k] of the 2k^{th} stage ST[2k] and the second node R[k] of the k^{th} common control circuit CC[k].

The driving circuit DRV according to some example embodiments may be configured to control the voltage level of the first control node QB[2k−1] of the (2k−1)^{th} stage ST[2k−1] and the voltage level of the first control node QB[2k] of the 2k^{th} stage ST[2k] through the k^{th} common control circuit CC[k], thereby significantly reducing power consumption. An area required (or used) by the driving circuit DRV according to some example embodiments may be reduced compared to a case where each stage includes the second node control circuit.

The k^{th} common control circuit CC[k] of FIG. 12 includes the fourth transistor M4 and the fifth transistor M5 that are connected in series between the first voltage terminal V1 and the third voltage terminal V3, but the disclosure is not limited thereto. The k^{th} common control circuit CC[k] may further include transistors and capacitors, and known structures for controlling a voltage level of a first control node may be applied.

The display apparatus 100 according to some example embodiments includes the driving circuit DRV, and the display apparatus 100 may be applied to various electronic apparatuses. An electronic apparatus according to some example embodiments includes the display apparatus 100, and may further include a module or apparatus having other additional functions, in addition to the display apparatus 100.

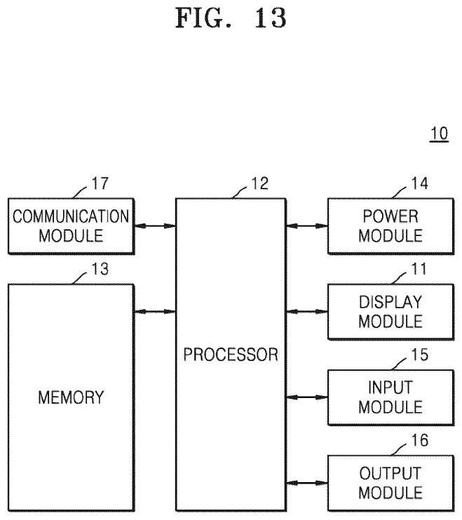

FIG. 13 is a block diagram of an electronic apparatus according to some example embodiments.

Referring to FIG. 13, an electronic apparatus 10 according to some example embodiments may include a display module 11, a processor 12, a memory 13, and/or a power module 14. The electronic apparatus 10 may further include an input module 15, a non-image output module 16, and/or a communication module 17. According to some example embodiments, operations described herein as being performed by the electronic apparatus 10, the display module 11, the processor 12, the power module 14, the input module 15, the non-image output module 16, and/or the communication module 17 may be performed by processing circuitry.

The electronic apparatus 10 may output various information in the form of an image through the display module 11. When the processor 12 executes an application stored in the memory 13, image information provided by the application may be provided to a user through the display module 11. The power module 14 may include a power supply module, such as a power adapter or a battery apparatus, and a power conversion module that converts power supplied by the power supply module and generates power required (or used) to operate the electronic apparatus 10. The input module 15 may provide input information to the processor 12 and/or the display module 11. The non-image output module 16 may receive information, for example, information about sound, haptic feedback, light emission, etc., other than an image received from the processor 12, and provide the information to a user. The communication module 17 is responsible for transmission and reception of information between the electronic apparatus 10 and an external apparatus, and may include a receiver and a transmitter.

In some example embodiments, the processor 12 may be provided as two or more separate units from a functional or structural perspective. For example, the processor 12 may include a main processor in the form of a first driving chip including a central processing unit and an auxiliary processor in the form of a second driving chip including the controller 190 (see FIG. 1), wherein the auxiliary processor receives an image signal from the main processor and processes the image signal to satisfy interface specifications of the display module 11. The controller 190 (see FIG. 1) may be included in the display apparatus 100.

The memory 13 may include at least one of non-volatile memory and volatile memory. The memory 13 may store data information required (or used) to operate the processor 12 or the display module 11. When the processor 12 executes an application stored in the memory 13, an image data signal and/or an input control signal may be transmitted to the display module 11, and the display module 11 may process the received signal and output image information via a display screen.

The power module 14 may include a power supply module, such as a power adapter or a battery apparatus, and a power conversion module that converts power supplied by the power supply module and generates power required (or used) to operate the electronic apparatus 10. Power conversion by the power conversion module may include DC-DC conversion, AC-DC conversion, and DC-AC conversion, but is not limited thereto.

The input module 15 may provide input information to the processor 12 and/or the display module 11. The input module 15 may include a physical button, a keyboard, a microphone, and various sensor modules. Examples of a sensor module may include not only a touch sensor, a pressure sensor, a distance sensor, a location sensor, a digitizer, a motion recognition sensor, a camera sensor, a light-receiving sensor, a photoelectric conversion sensor, and a temperature sensor, but also a biometric sensor such as a blood pressure sensor, a blood glucose sensor, an electrocardiogram sensor, and a heart rate sensor.

The non-image output module 16 may receive information other than an image received from the processor 12 and provide the information to a user. Examples of the non-image output module 16 may include an audio module, a haptic module, and a light-emitting module, and may include other functional modules (for example, a cooling module of a refrigerator) that are unique to the electronic apparatus 10.

The communication module 17 is responsible for transmission and reception of information between the electronic apparatus 10 and an external apparatus, and may include a receiver and a transmitter. The communication module 17 may include various wireless communication modules such as a mobile communication module, a Wi-Fi module, and a Bluetooth module, or various wired communication modules.

At least one of the components of the electronic apparatus 10 may be included in the display apparatus 100 (see FIG. 1) according to the above-described examples. In addition, some individual modules functionally included within one module may be included in the display apparatus 100, and other individual modules may be provided separately from the display apparatus 100. For example, the display apparatus 100 may include the display module 11, and the processor 12, the memory 13, and the power module 14 may be provided in the form of other apparatuses within the electronic apparatus 10 other than the display apparatus 100. In another example, the power module 14 may be provided within the display apparatus 100 and may supply power to the processor 12 and the memory 13, which are provided within the electronic apparatus 10 rather than the display apparatus 100, and these examples are not limited thereto.

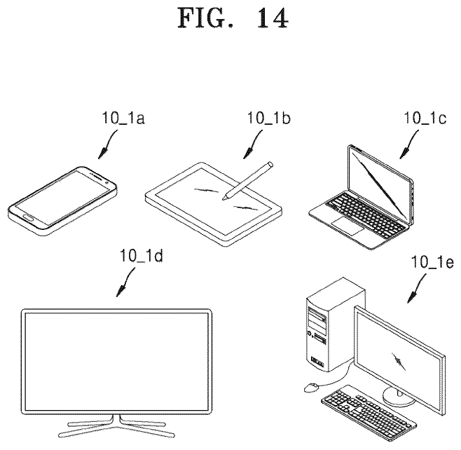

FIGS. 14 to 16 are schematic views of electronic apparatuses according to some example embodiments.

FIGS. 14 to 16 show examples of various electronic apparatuses to which a display apparatus according to some example embodiments is applied.

FIG. 14 shows, as examples of an electronic apparatus, a smartphone 10_1a, a tablet Personal Computer (PC) 10_1b, a laptop 10_1c, a Television (TV) 10_1d, and/or a desk monitor 10_1e.

The smartphone 10_1a may include an input module, such as a touch sensor, and a communication module, in addition to the display module 11. The smartphone 10_1a may process information received through the communication module or other input modules and display the information through a display module of the display apparatus.

Similar to the smartphone 10_1a, the tablet PC 10_1b, the laptop 10_1c, the TV 10_1d, and the desk monitor 10_1e may include a display module and an input module, and in some cases, may further include a communication module.

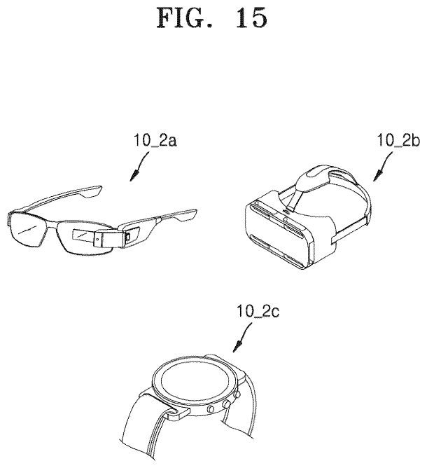

FIG. 15 shows a case where an electronic apparatus including a display module is applied to a wearable electronic apparatus. The wearable electronic apparatus may include smart glasses 10_2a, a head-mounted display 10_2b, and a smart watch 10_2c.

The smart glasses 10_2a and the head-mounted display 10_2b may include: a display module that displays a display image; and a reflector that reflects a displayed display screen and provides it to a user's eyes, thereby providing a virtual reality or augmented reality screen to the user.

The smart watch 10_2c may include a biometric sensor as an input apparatus, and may provide biometric information recognized by a biometric sensor to a user through a display module.

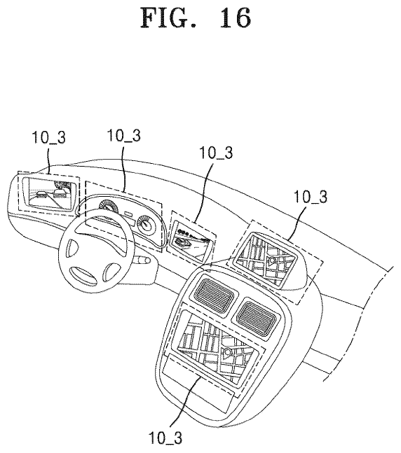

FIG. 16 shows a case where an electronic apparatus including a display module is applied to a vehicle. For example, an electronic apparatus 10_3 may be applied to an instrument panel of a vehicle or a center fascia, or may be applied to a center information display (CID) arranged on the dashboard of a vehicle or a room mirror display in place of side-view mirrors.

Although not shown, the electronic apparatus 10 to which the display apparatus 100 is applied according to some example embodiments may include not only apparatuses focused on screen display, such as billboards, electronic billboards, and game device, but also various home appliances that display information through a display module, such as refrigerators, washing machines, dryers, air conditioners, and robot vacuums. In addition, when a display module has a function of transmitting light, the display module may be applied to an electronic apparatus such as a smart window or a transparent display apparatus that displays a background and a display image together. The type of electronic apparatus 10 according to some example embodiments is not limited to the example provided above, and the application of other various electronic apparatuses that are not provided as examples is also possible.

According to some example embodiments, it is possible to implement a driving circuit and an electronic apparatus including the same, where the driving circuit not only stably outputs an emission control signal, but also has reduced power consumption. However, the scope of the disclosure is not limited thereto.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 13). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

When one constituent element is described as being “coupled” or “connected” to another constituent element, it should be understood that one constituent element may be coupled or connected directly to another constituent element, and an intervening constituent element may also be present between the constituent elements. When one constituent element is described as being “coupled directly to” or “connected directly to” another constituent element, it should be understood that no intervening constituent element exists between the constituent elements.

It should be understood that some example embodiments described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope as defined by the following claims.

What is claimed is:

1. A driving circuit comprising:
a plurality of stages;
common control circuits configured to control a voltage level of a first control node of each of a consecutive pair of stages among the plurality of stages; and
switch transistors configured to electrically connect each of the common control circuits to corresponding stages among the plurality of stages according to clock signals input to gates of the switch transistors, each of the plurality of stages including,
an input circuit configured to transmit a start signal to a second control node according to a first clock signal input to a first clock terminal, the start signal being input to an input terminal, and the first clock signal being among the clock signals,
a node control circuit configured to control a voltage level of the second control node,
a charge pump circuit configured to control a voltage level of a third control node according to a second clock signal input to a second clock terminal, the second clock signal being among the clock signals, and
an output circuit configured to,
output a carry signal to a first output terminal based on the voltage level of the first control node and the voltage level of the third control node, and
output an output signal to a second output terminal based on the voltage level of the first control node and the voltage level of the third control node.

2. The driving circuit of claim 1, wherein
the plurality of stages include a (2k−1)^{th} stage and a 2k^{th} stage that are electrically connected to a k^{th} common control circuit among the common control circuits;
the second clock signal is that is phase-shifted by a half cycle from the first clock signal;
the first clock signal is input to the first clock terminal of the (2k−1)^{th} stage;
the second clock signal is input to the second clock terminal of the (2k−1)^{th} stage;
the second clock signal is input to the first clock terminal of the 2k^{th} stage;
the first clock signal is input to the second clock terminal of the 2k^{th} stage; and
k is a natural number greater than or equal to 1.

3. The driving circuit of claim 2, wherein the k^{th} common control circuit comprises:
a first transistor electrically connected between a first node and a double clock terminal to which a double clock signal is input, the first transistor including a gate electrically connected to a second node;
a second transistor electrically connected between the first node and a first voltage terminal to which a first low level voltage is supplied, the second transistor including a gate electrically connected to the second control node of the (2k−1)^{th} stage;
a third transistor electrically connected between the second node and the first voltage terminal, the third transistor including a gate electrically connected to the input terminal of the (2k−1)^{th} stage; and
a first capacitor electrically connected between the double clock terminal and the second node.

4. The driving circuit of claim 3, wherein the switch transistors comprise:
a first switch transistor configured to electrically connect the k^{th} common control circuit to the (2k−1)^{th} stage according to the first clock signal; and
a second switch transistor configured to electrically connect the k^{th} common control circuit to the 2k^{th} stage according to the second clock signal.

5. The driving circuit of claim 4, wherein
the first switch transistor is electrically connected between the first node of the k^{th} common control circuit and the second control node of the (2k−1)^{th} stage; and
the second switch transistor is electrically connected between the first node of the k^{th} common control circuit and the second control node of the 2k^{th} stage.

6. The driving circuit of claim 3, wherein one period of the double clock signal is longer than one period of each of the clock signals.

7. The driving circuit of claim 6, wherein one period of the double clock signal is twice as long as one period of each of the clock signals.

8. The driving circuit of claim 3, wherein
each of the first transistor, the second transistor, and the third transistor includes two sub-transistors connected in series;
the k^{th} common control circuit further includes,
a fourth transistor electrically connected between a first sub-node and a second voltage terminal to which a high-level voltage is supplied, the sub-transistors of the first transistor being connected to each other at the first sub-node;
a fifth transistor electrically connected between a second sub-node and the second voltage terminal, the sub-transistors of the second transistor being connected to each other at the second sub-node; and
a sixth transistor electrically connected between a third sub-node and the second voltage terminal, the sub-transistors of the third transistor being connected to each other at the third sub-node; and
a gate of each of the fourth transistor, the fifth transistor, and the sixth transistor is electrically connected to the first node.

9. The driving circuit of claim 2, wherein the k^{th} common control circuit comprises:
a first transistor electrically connected between a first node and a first voltage terminal to which a high-level voltage is supplied, the first transistor including a gate electrically connected to the first voltage terminal; and
a second transistor electrically connected between the first node and a second voltage terminal to which a low-level voltage is supplied, the second transistor including a gate electrically connected to the second control node of the (2k−1)^{th} stage.

10. The driving circuit of claim 1, wherein
the input circuit includes a first transistor electrically connected between the input terminal and the second control node, the first transistor including a gate electrically connected to the first clock terminal; and
the node control circuit includes a second transistor electrically connected between the second control node and a first voltage terminal to which a first low level voltage is supplied, the second transistor including a gate electrically connected to the first control node.

11. The driving circuit of claim 10, wherein
the second transistor includes two sub-transistors connected in series; and
each of the plurality of stages further includes a third transistor electrically connected between a fourth sub-node and a second voltage terminal to which a high-level voltage is supplied, the sub-transistors of the second transistor being connected to each other at the fourth sub-node, and the third transistor including a gate electrically connected to the second control node.

12. The driving circuit of claim 1, wherein the output circuit comprises:
a first transistor electrically connected between the first output terminal and a first voltage terminal to which a high-level voltage is supplied, the first transistor including a gate electrically connected to the third control node;
a second transistor electrically connected between the first output terminal and a second voltage terminal to which a first low level voltage is supplied, the second transistor including a gate electrically connected to the first control node;
a third transistor electrically connected between the first voltage terminal and the second output terminal, the third transistor including a gate electrically connected to the third control node; and
a fourth transistor electrically connected between the second output terminal and a third voltage terminal to which a second low level voltage is supplied, the fourth transistor including a gate electrically connected to the first control node.

13. The driving circuit of claim 12, wherein the output circuit further comprises:
a first capacitor electrically connected between the gate of the third transistor and the second output terminal; and
a second capacitor electrically connected between the gate of the fourth transistor and the third voltage terminal.

14. The driving circuit of claim 12, wherein
the first output terminal is electrically connected to the input terminal of a subsequent stage; and
the second output terminal is electrically connected to a corresponding emission control line.

15. The driving circuit of claim 1, wherein the charge pump circuit comprises:
a first transistor electrically connected to the second clock terminal, the first transistor including a gate electrically connected to the third control node; and
a first capacitor electrically connected between the first transistor and the third control node.

16. The driving circuit of claim 1, wherein
the plurality of stages and the common control circuits each include a plurality of transistors; and
each of the plurality of transistors includes an oxide thin-film transistor that includes an oxide semiconductor material.

17. An electronic apparatus comprising:
a main processor;
a display apparatus including a pixel and a driving circuit, the driving circuit being configured to supply an output signal to the pixel; and
a controller electrically connected to the display apparatus, the controller is configured to output a driving control signal to the display apparatus based on a signal received from the main processor,
wherein the driving circuit includes,
a plurality of stages configured to,
control a voltage level of each of a first control node, a second control node, and a third control node based on a start signal and clock signals, and
output a carry signal and the output signal based on the voltage level of each of the first control node, the second control node, and the third control node,
common control circuits configured to control the voltage level of the first control node of each of a consecutive pair of stages among the plurality of stages, and
switch transistors configured to electrically connect each of the common control circuits to corresponding stages among the plurality of stages according to the clock signals input to gates of the switch transistors.

18. The electronic apparatus of claim 17, wherein each of the plurality of stages comprises:
an input circuit configured to transmit the start signal according to a first clock signal input to a first clock terminal, the start signal being input into an input terminal, and the first clock signal being among the clock signals;
a node control circuit configured to control the voltage level of the second control node;
a charge pump circuit configured to control the voltage level of the third control node according to a second clock signal input to a second clock terminal, the second clock signal being among the clock signals; and
an output circuit configured to,
output the carry signal to a first output terminal based on the voltage level of the first control node and the voltage level of the third control node, and
output the output signal to a second output terminal based on the voltage level of the first control node and the voltage level of the third control node.

19. The electronic apparatus of claim 18, wherein
the plurality of stages include a (2k−1)^{th} stage and a 2k^{th} stage that are electrically connected to a k^{th} common control circuit among the common control circuits; and
the k^{th} common control circuit includes,
a first transistor electrically connected between a first node and a double clock terminal to which a double clock signal is input, the first transistor including a gate electrically connected to a second node,
a second transistor electrically connected between the first node and a first voltage terminal to which a first low level voltage is supplied, the second transistor including a gate electrically connected to the second control node of the (2k−1)^{th} stage,
a third transistor electrically connected between the second node and the first voltage terminal, the third transistor including a gate electrically connected to the input terminal of the (2k−1)^{th} stage, and
a first capacitor electrically connected between the double clock terminal and the second node.

20. The electronic apparatus of claim 18, wherein
the plurality of stages include a (2k−1)^{th} stage and a 2k^{th} stage that are electrically connected to a k^{th} common control circuit among the common control circuits; and
the k^{th} common control circuit includes,
a first transistor electrically connected between a first node and a first voltage terminal to which a high-level voltage is supplied, the first transistor including a gate electrically connected to the first voltage terminal, and
a second transistor electrically connected between the first node and a second voltage terminal to which a low-level voltage is supplied, the second transistor including a gate electrically connected to the second control node of the (2k−1)^{th} stage.
